(19) United States
(12) Patent Application Publication
(10) Pub. No.: US 2007/0079075 A1
(43) Pub. Date: Apr. 5, 2007

(54) Providing cache coherency in an extended multiple processor environment

(76) Inventors: Josh D. Collier, Royersford, PA (US); Joseph S. Schibinger, Phoenixville, PA (US); Craig R. Church, Wayne, PA (US)

Correspondence Address: Unisys Corporation;Attn: Richard Gregson, Unisys Way, MS/E8-114, Blue Bell, PA, 19424-0001, US

(21) Appl. No.: 11/540,886

(22) Filed: Sep. 29, 2006

Related U.S. Application Data
(60) Provisional application No. 60/722,092, filed on Sep. 30, 2005.
(60) Provisional application No. 60/722,317, filed on Sep. 30, 2005.
(60) Provisional application No. 60/722,623, filed on Sep. 30, 2005.
(60) Provisional application No. 60/722,633, filed on Sep. 30, 2005.

(51) Int. Cl. G06F 13/28

(52) U.S. Cl. 711/141; 711/146

(57) ABSTRACT

A method and system for scaling upwards a multiprocessor cache coherency scheme includes at least two cells. Each cell containing a multiple processor assembly, a cache coherency director, and a system controller. The cache coherency director include an intermediate home agent (IHA) and an intermediate cache agent (ICA). An IHA in one cell communicates with an ICA in another cell to arbitrate the availability of lines of cache that are requested by a processor in one of the cells. A protocol that includes request retries avoids system lockups is used as the basis for inter-cell cache coherency communication.

### CROSS REFERENCE TO RELATED APPLICATIONS

This application claims benefit under 35 U.S.C. §119(e) of provisional U.S. Pat. Ser. Nos. 60/722,092, 60/722,317, 60/722,623, and 60/722,633 all filed on Sep. 30, 2005, the disclosures of which are incorporated herein by reference in their entirely.

The following commonly assigned co-pending applications have some subject matter in common with the current application:

U.S. application Ser. No. 11/______ filed Sep. 29, 2006, entitled “Tracking Cache Coherency In An Extended Multiple Processor Environment”, attorney docket number TN428, which is incorporated herein by reference in its entirety;

U.S. application Ser. No. 11/______ filed Sep. 29, 2006, entitled “Preemptive Eviction Of Cache Lines From A Directory”, attorney docket number TN426, which is incorporated herein by reference in its entirety; and

U.S. application Ser. No. 11/______ filed Sep. 29, 2006, entitled “Dynamic Presence Vector Scaling in a Coherency Directory”, attorney docket number TN422, which is incorporated herein by reference in its entirety.

### FIELD OF THE INVENTION

The current invention relates generally to data processing systems, and more particularly to systems and methods for providing cache coherency between cells having multiple processors.

### BACKGROUND OF THE INVENTION

A multiprocessor environment can include a shared memory including shared lines of cache. In such a system, a single line of cache may be used or modified by one processor in the multiprocessor system. In the event a second processor desires to use that same line of cache, the possibility exists for contention. Ownership and control of the specific line of cache is preferably managed so that different sets of data for the same line of cache do not appear in different processors at the same time. It is therefore desirable to have a coherent management system for cache in a shared cache multiprocessor environment. The present invention addresses the aforementioned needs and solves them with additional advantages as expressed herein.

### SUMMARY OF THE INVENTION

An embodiment of the invention includes a method of maintaining cache coherency between at least two multiprocessor assemblies in at least two cells. The embodiment includes a cache coherency director in each cell. Each cache coherent director contains an intermediate home agent (IHA), an intermediate cache agent (ICA), and access to a remote directory. If a processor in one cell requests a line of cache that is not present in the local cache stores of each of the processors in the multiprocessor component assembly, then the IHA of the requesting cell reads the remote directory and determines if the line of cache is owned by a remote entity. If a remote entity does have control of the line of cache, then a request is sent from the requesting cell IHA to the target cell ICA. The target cell ICA finds the line of cache using the target IHA and requests release of the line of cache so that the requesting cell may have access. After the target cell processor releases the line of cache, the request cell processor may have access to the desired line of cache.

In one embodiment, the invention includes a communication protocol between cells which allows one cell to request a line of cache from a target cell. To avoid system dead locks as well as the expense of extremely large pre-allocated buffer storage, a retry mechanism is included. In addition, the protocol also includes a fairness mechanism which guarantees the eventual execution of requests.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of a multiprocessor system;

FIG. 2 is a block diagram of two cells having multiprocessor system assemblies;

FIG. 3 is a block diagram showing interconnections between cells;

FIG. 4a is a block diagram of an example shared multiprocessor system (SMS) architecture;

FIG. 4b is a block diagram of an example SMS showing additional cell and socket level detail;

FIG. 4c is a block diagram of an example SMS showing a first part of an example set of communications transactions between cells and sockets for an unshared line of cache;

FIG. 4d is a block diagram of an example SMS showing a second part of an example set of communications transactions between cells and sockets for an unshared line of cache;

FIG. 4e is a block diagram of an example SMS showing a first of three parts of an example set of communications transactions between cells and sockets for a shared line of cache;

FIG. 4f is a block diagram of an example SMS showing a second of three parts of an example set of communications transactions between cells and sockets for a shared line of cache;

FIG. 4g is a block diagram of an example SMS showing a third of three parts of an example set of communications transactions between cells and sockets for a shared line of cache;

FIG. 5 is a block diagram of an intermediate home agent;

FIG. 6 is a block diagram of an intermediate caching agent;

FIG. 7 is a source broadcast flow diagram;

FIG. 8 is a home broadcast flow diagram; and

FIG. 9 is a flow diagram of a cache management scheme employed in an embodiment of the invention.

### DETAILED DESCRIPTION OF ILLUSTRATIVE EMBODIMENTS

Related Applications

This application has some content in common with co-filed and co-owned U.S. patent applications which disclose distinct but compatible aspects of the current invention. Thus, U.S. application Ser. No. 11/______ filed Sep. 30, 2006, entitled “Tracking Cache Coherency In An Extended Multiple Processor Environment” and U.S. application Ser. No. 11/______ filed Sep. 30, 2006, entitled “Preemptive Eviction Of Cache Lines From A Directory” and U.S. application Ser. No. 11/______ filed Sep. 30, 2006, entitled “Dynamic Presence Vector Scaling in a Coherency Directory” are all incorporated herein by reference in their entirety.

Multiprocessor Component Assembly

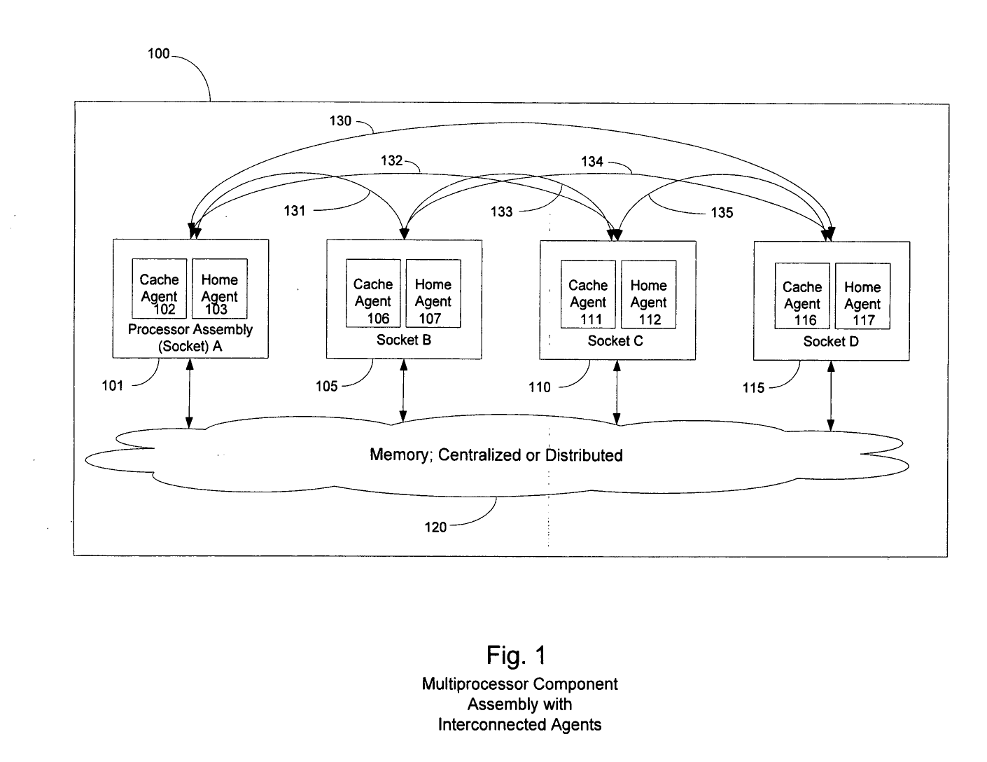

FIG. 1 is a block diagram of an exemplary multiple processor component assembly that is included as one of the components of the current invention. The multiprocessor component assembly 100 of FIG. 1 depicts a multiprocessor system component having multiple processor sockets 101, 105, 110, and 115. All of the processor sockets have access to memory 120. The memory 120 may a centralized shared memory or may be a distributed shared memory. Access to the memory 120 by the sockets A-D 101, 105, 110, and 115 depends on whether the memory is centralized or grouped. If centralized, then each socket may have a dedicated connection to memory or the connection may be shared as in a buss configuration. If distributed, each socket may have a memory agent (not shown) and an associated memory block.

The sockets A-D 101, 105, 110, and 115 may communicate with one another via communication links 130-135. The communication links are arranged such that any socket may communicate with any other socket over one of the inter-socket links 130-135. Each socket contains at least one cache agent and one home agent. For example, socket A 101 contains cache agent 102 and home agent 103. Sockets B-D 105, 110, and 115 are similarly configured.

In multiprocessor component assembly 100, caching of information useful to one or more of the processor assemblies (socket) A-D is accommodated in a coherent fashion such that the integrity of the information stored in memory 120 is maintained. Coherency in component 100 may be defined as the management of a cache in an environment having multiple processing entities. Cache may be defined as local temporary storage available to a processor. Each processor, while performing its programming tasks, may request and access a line of cache. A cache line is a fixed size of data, useable as a cache, that is accessible and manageable as a unit. For example, a cache line may be some arbitrarily fixed size of bytes of memory. A cache line is the unit size upon which a cache is managed. For example, if the memory 120 is 64 MB in total size and each cache lines is sized to be 64 Bytes, then 64 MB of memory/64 bytes cache line size=1 Meg of different cache lines.

Cache may have multiple states. One convention indicative of multiple cache states is called the MESI system. Here, a line of cache can be one of: modified (M), exclusive (E), shared (S), or invalid (I). Each socket entity in the shared multiprocessor component 100 may have one or more cache lines in each of these different states. Multiple processors (or caching agents) can simultaneous have read-only copies (Shared coherency state) but only one caching agent can have a writable copy (Exclusive or Modified coherency state) at a time.

An exclusive state is indicative of a condition where only one entity, such as a socket, has a particular cache line in a read and write state. No other sockets have concurrent access to this cache line. A modified state is indicative of an exclusive state where the contents of the cache line varies from what is in shared memory 120. Thus, an entity, such as a processor assembly or socket, is the only entity that has the line of cache, but the line of cache is different from the cache that is stored in memory. One reason for the difference is that the entity has modified the content of the cache after it was granted access in exclusive or modified state. The implication here is that if any other entity were to access the same line of cache from memory, the line of cache from memory may not be the freshest data available for that particular cache line. When a node has exclusive access, all other nodes in the system are in the invalid state for that cache line. A node with exclusive access may modify all or part of the cache line or may silently invalidate the cache line. A node with exclusive state will be snooped (searched and queried) when another node attempts to gain any state other than the invalid state.

Another state of cache is known as the modified state. Modified indicates that the cache line is present at a node in a modified state, and that the node guarantees to provide the full cache line of data when snooped. When a node has modified access, all other nodes in the system are in the invalid state with respect to the requested line of cache. A node with modified access may modify all or part of the cache line, but always either writes the whole cache line back to memory to evict it from its cache or provides the whole cache line in a snoop response.

Another mode or state of cache is known as shared. As the name implies, a shared line of cache is cache information that is a read-only copy of the data. In this cache state type, multiple entities may have read this cache line out of shared memory. Additionally, if one node has the cache line shared, it is guaranteed that no other node has the cache line in a state other than shared or invalid. A node with shared state only needs to be snooped when another node is attempting to gain either exclusive or modified access.

An invalid cache line state indicates that the entity does not have the cache line. In this state, another entity could have the cache line. Invalid indicates that the cache line is not present at an entity node. Accordingly, the cache line does not need to be snooped. In a multiprocessor environment, each processor is performing separate functions and has different caching scenarios. A cache line can be invalid, exclusive in one cache, shared by multiple read only processes, and modified and different from what is in memory. In coherent data access, an exclusive or modified cache line can only be owned by one agent. A shared cache line can be owned by more than one agent. Using write consistency, writes from an agent must be observed by all agents in the same order as the order they are written. For example, if agent 1 writes cache line (a) followed by cache line (b), then if another agent 2 observes a new value for (b) then agent 2 must also observe the new value of (a). In a system that has write consistency and coherent data access, it is desirable to have a scalable architecture that allows building very large configurations via distributed coherency controllers each with a directory of ownership.

In component 100 of FIG. 1, it may be assumed for simplicity that each socket has one processor. This may not be true in some systems, but this assumption will serve to explain the basic operation. Also, it may be assumed that a socket has within it a local store of cache where a line of cache may be stored temporarily while the processor is using the cache information. The local stores of cache can be a grouped local store of cache or it may be a distributed local store of cache within the socket.

If a processor within a socket 101 seeks a line of cache that is not currently resident in the local processor cache, the socket 101 may seek to acquire that line of cache. Initially, the processor request for a line of cache may be received by a home agent 103. The home agent arbitrates cache requests. If for example, there were multiple local cache stores, the home agent would search the local stores of cache to determine if the sought line of cache is present within the socket. If the line of cache is present, the local cache store may be used. However, if the home agent 103 fails to find the line of cache in cache local to the socket 101, then the home agent may request the line of cache from other sources.

The most logical source of a line of cache is the memory 120. However, in a shared multiprocessor environment, one or more of the processor assembly sockets B-D may have the desired line of cache. In this instance, it is important to determine the state of the line of cache so that when the requesting socket (A 101) accesses the memory, it acquires known good cache information. For example, if socket B had the line of cache that socket A were interested in and socket B had updated the cache information, but had not written that new information into memory, socket A would access stale information if it simply accessed the line of cache directly from memory without first checking on its status. Therefore, the status information on the desired line of cache is preferably retrieved first.

In the instance of the FIG. 1 topology, assume that socket A desires access to a line of cache that is not in its local socket 101 cache stores. The home agent 103 may then send out requests to the other processor assembly sockets, such as socket B 105, socket C 110, or socket C 115, to determine the status of the desired line of cache. One way of performing this inquiry is for the home agent 103 to generate requests to each of the other sockets for status on the cache line. For example, socket A 101 could request a cache line status from socket D 115 via communication line 130. At socket 130, the cache agent 116 would receive the request, determine the status of the cache line, and return a state status of the desired cache line. In a like fashion, the home agent 103 of socket 101 could also ask socket C 110 and socket B 105 in turn to get the state status of the desired cache line. In each of the sockets B 105, C 110, and D 115, the cache agent, 106, 111, and 116 respectively would receive the state request, process it, and return a state status of the line of cache. In general, each socket may have one or more cache agents.

The home agent 103 would process the responses. If the response from each socket indicates an invalid state, then the home agent 103 could access the desired cache line directly from memory 120 because no other socket entity is currently using the line of cache. If the returned results indicate a mixture of shared and invalid states or just all shared states, then the home agent 103 could access the desired cache line directly from memory 120 because the cache line is read only and is readily accessible without interference from other socket entities.

If the home agent 103 receives an indication that the desired lines of cache is exclusive or modified, then the home agent cannot simply access the line of cache from memory 120 if another socket entity has exclusive use of the line of cache or another entity has modified the cache information. If the current cache line is exclusive then depending on the request the owner must downgrade the state to shared or invalid and memory data can then be used. If the current state is modified then the owner also has to downgrade his cache line holding (except for a “read current value” request) and then 1) the data can be forwarded in the modified state to the requester, or 2) the data must be forwarded to the requester and then memory is updated or 3) memory updated and then sent to the requester. In the instance where the requested cache line is exclusively held, the socket entity that indicated the line of cache is exclusive does not need to return the cache line to memory since the memory copy is up to date. The holding agent can then later provide a status to home agent 103 that the line of cache is invalid or shared. The host agent 103 can then access the cache from memory 120 safely. The same basic procedure is also taken with respect to a modified state status return. The modifying socket may write the modified cache line information to memory 120 and return an invalid state to home agent 103. The home agent 103 may then allow access to the line of cache in memory because no other entity has the line of cache in exclusive or modified use and the cache line of information is safe to read from memory 120. Given a request for a line of cache, the cache holding agent can provide the modified cache line directly to the requestor and then downgrade to shared state or the invalid state as required by the snoop request and/or desired by the snooped agent. The requester then either maintains the modified state or updates memory and retains exclusive, shared, or modified ownership.

One aspect of the multiprocessor component assembly 100 shown in FIG. 1 is that it is extensible to include up to N processor assembly sockets. That is, many sockets may be interconnected. However, there are limitations. For example, the inter-processor communications links 130-135 increase with increased numbers of sockets. In the system of FIG. 1, each socket has the capability to communicate with three other sockets. Adding additional sockets onto the system increases the number of communications link interfaces according to the topology of the interconnect. In a fully connected topology, adding an Nth socket requires adding N-1 links. In one example, the system communication increase may increase non-linearly as follows: (Links=0, 1, 3, 6, 10, . . . for 1, 2, 3, 4, 5, . . . sockets.) Another limitation is that as the number of sockets increase in the component 100, the time to perform a broadcast rapidly increases with the number of sockets. This has the effect of slowing down the system. Another limitation of expanding component assembly 100 to N sockets is that the component assembly 100 may be prone to single point reliability failures where one failure may have a collateral failure effect on other sockets. A failure a power converter for the multiple processor system assembly can bring down the entire N wide assembly. Accordingly, a more flexible extension mechanism is desirable.

Scaling Up the Shared Cache Multiprocessor Component Environment

The architecture of FIG. 1 may be scaled up to avoid the extension difficulties expressed above. With the foregoing available for discussion purposes, the current invention is described in regards to the remaining drawings.

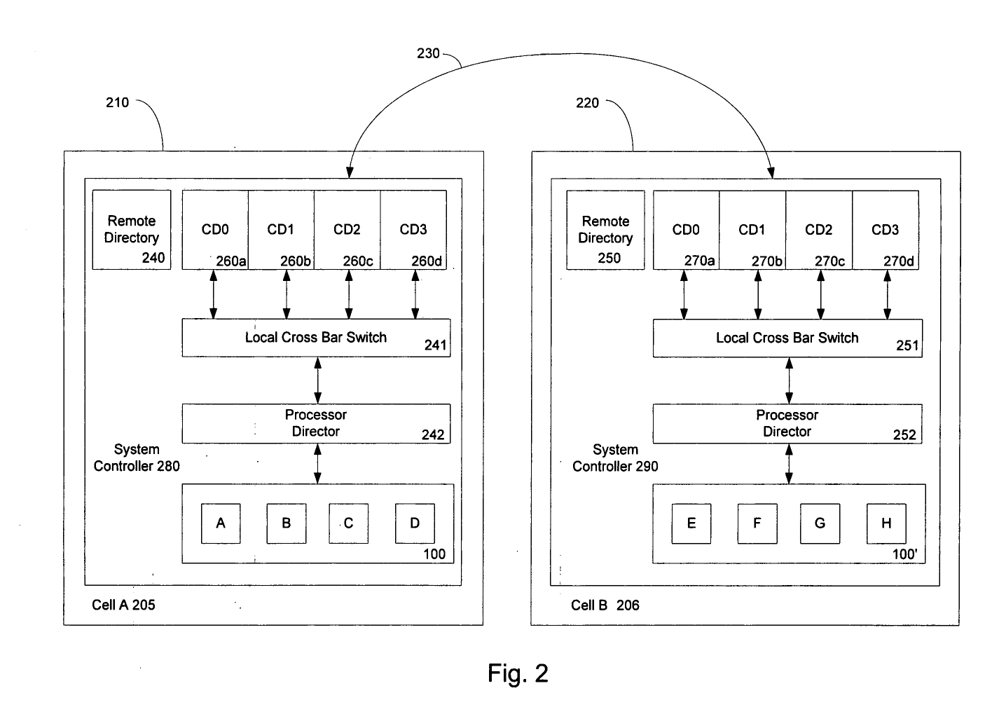

FIG. 2 depicts a system where the multiprocessor component assembly 100 of FIG. 1 may be expanded to include other similar systems assemblies without the disadvantages of slow access times and single points of failure. FIG. 2 depicts two cells; cell A 205 and cell B 206. Each cell contains a system controller (SC) 280 and 290 respectively that contain the functionality in each cell. Each cell contains a multiprocessor component assembly, 100 and 100′ respectively. Within Cell A 205 and SC 280, a processor director 242 interfaces the specific control, timing, data, and protocol aspects of multiprocessor component assembly 100. Thus, by tailoring the processor director 242, any manufacturer of multiprocessor component assembly may be used to accommodate the construction of Cell A 205. Processor Director 242 is interconnected to a local cross bar switch 241. The local cross bar switch 241 is connected to four coherency directors (CD) labeled 260a-d. This configuration of processor director 242 and local cross bar switch 241 allow the four sockets A-D of multiprocessor component assembly 100 to interconnect to any of the CDs 260a-d. Cell B 206 is similarly constructed. Within Cell b 206 and SC 290, a processor director 252 interfaces the specific control, timing, data, and protocol aspects of multiprocessor component assembly 100′. Thus, by tailoring the processor director 252, any manufacturer of multiprocessor component assembly may be used to accommodate the construction of Cell A 206. Processor Director 252 is interconnected to a local cross bar switch 251. The local cross bar switch 251 is connected to four coherency directors (CD) labeled 270a-d. As described above, this configuration of processor director 252 and local cross bar switch 251 allow the four sockets E-H of multiprocessor component assembly 100′ to interconnect to any of the CDs 270a-d.

The coherency directors 260a-d and 270a-d function to expand component assembly 100 in Cell A 205 to be able to communicate with component assembly 100′ in Cell B 206. A coherency director (CD) allows the inter-system exchange of resources, such as cache memory, without the disadvantage of slower access times and single points of failure as mentioned before. A CD is responsible for the management of a lines of cache that extend beyond a cell. In a cell, the system controller, coherency director, remote directory, coherency director are preferably implemented in a combination of hardware, firmware, and software. In one embodiment, the above elements of a cell are each one or more application specific integrated circuits.

In one embodiment of a CD within a cell, when a request is made for a line of cache not within the component assembly 100, then the cache coherency director may contact all other cells and ascertain the status of the line of cache. As mentioned above, although this method is viable, it can slow down the overall system. An improvement can be to include a remote directory into a call, dedicated to the coherency director to act as a lookup for lines a cache.

FIG. 2 depicts a remote directory (RDIR) 240 in Cell a 205 connected to the coherency directors (CD) 260a-d. Cell B 206 has its own RDIR 250 for CDs 270a-d. The RDIR is a directory that tracks the ownership or state of cache lines whose homes are local to the cell A 205 but which are owned by remote nodes. Adding a RDIR to the architecture lessens the requirement to query all agents as to the ownership of non-local requested line of cache. In one embodiment, the RDIR may be a set associative memory. Ownership of local cache lines by local processors is not tracked in the directory. Instead, as indicated before communication queries (also known as snoops) between processor assembly sockets are used to maintain coherency of local cache lines in the local domain. In the event that all locally owned cache lines are local cache lines, then the directory would contain no entries. Otherwise, the directory contains the status or ownership information for all memory cache lines that are checked out of the local domain of the cell. In one embodiment, if the RDIR indicates a modified cache line state, then a snoop request must be sent to obtain the modified copy and depending on the request the current owner downgrades to exclusive, shared, or invalid state. If the RDIR indicates an exclusive state for a line of cache, then a snoop request must be sent to obtain a possibly modified copy and depending on the request the current owner downgrades to exclusive, shared, or invalid state. If the RDIR indicates a shared state for a requested line of cache, then a snoop request must be sent to invalidate the current owner(s) if the original request is for exclusive. In this case it the local caching agents may also have shared copies so a snoop is also sent to the local agents to invalidate the cache line. If an RDIR indicates that the requested line of cache is invalid, then a snoop request must be sent to local agents to obtain a modified copy if it exists locally and/or downgrade the current owner(s) as required by the request. In an alternate embodiment, the requesting agent can perform this retrieve and downgrade function locally using a broadcast snoop function.

If a line of cache is checked out to another cell, the requesting cell can inquire about its status via the interconnection between cells 230. In one embodiment, this interconnection is a high speed serial link with a specific protocol termed Unisys® Scalability Protocol (USP). This protocol allows one cell to interrogate another cell as to the status of a cache line.

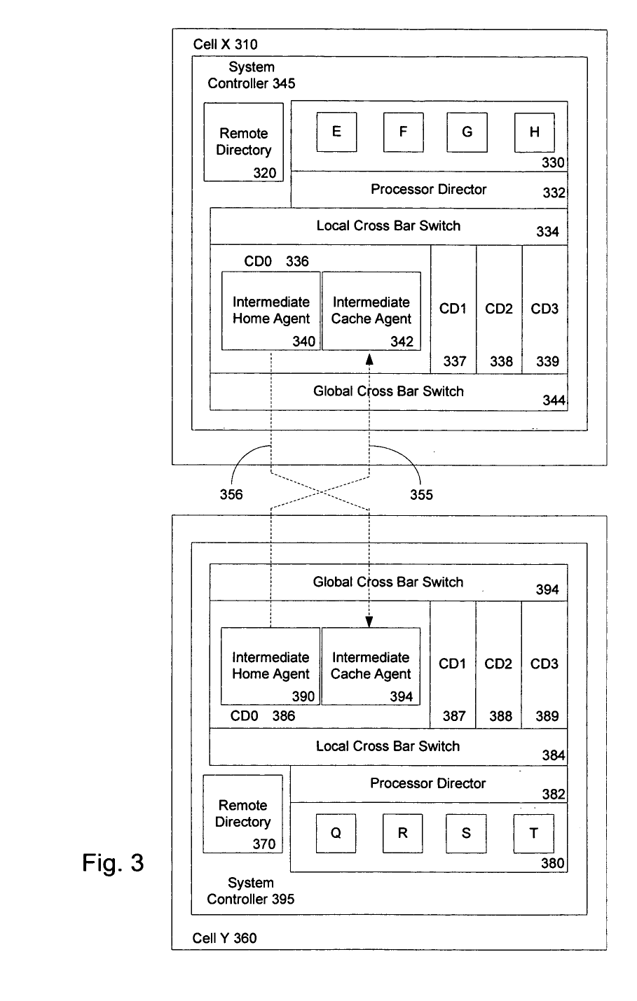

FIG. 3 depicts the interconnection between two cells; X 310 and Y 380. Considering cell X 310, structural elements include a SC 345, a multiprocessor system 330, processor director 332, a local cross bar switch 334 connecting to the four CDs 336-339, a global cross bar switch 344 and remote directory 320. The global cross bar switch allows connection from any of the CDs 336-339 and agents within the CDs to connect to agents of CDs in other cells. CD 336 further includes an entity called an intermediate home agent (IHA) 340 and an intermediate cache agent (ICA) 342. Likewise, Cell Y 360 contains a SC 395, a multiprocessor system 380, processor director 382, a local cross bar switch 384 connecting to the four CDs 386-389, a global cross bar switch 394 and remote directory 370. The global cross bar switch allows connection from any of the CDs 386-389 and agents within the CDs to connect to agents of CDs in other cells. CD 386 further includes an entity called an intermediate home agent (IHA) 390 and an intermediate cache agent (ICA) 394.

The IHA 340 of Cell X 310 communicates to the ICA 394 of Cell Y 360 using path 356 via the global cross bar paths in 344 and 394. Likewise, the IHA 390 of Cell Y 360 communicates to the ICA 344 of Cell X 360 using path 355 via the global cross bar paths in 344 and 394. In cell X 310, IHA 340 acts as the intermediate home agent to multiprocessor assembly 330 when the home of the request is not in assembly 330 (i.e. the home is in a remote cell). From a global view point, the ICA of the cell that contains the home of the request is the global home and the IHA is viewed as the global requester. Therefore the IHA issues a request to the home ICA to obtain the desired cache line. The ICA has an RDIR that contains the status of the desired cache line. Depending on the status of the cache line and the type of request the ICA issues global requests to global owners (IHAs) and may issue the request to the local home. Here the ICA acts as a local caching agent that is making a request. The local home will respond to the ICA with data; the global caching agents (IHAs) issue snoop requests to their local domains. The snoop responses are collected and consolidated to a single snoop response which is then sent to the requesting IHA. The requesting agent collects all the (snoop and original) responses, consolidates them (including its local responses) and generates a response to its local requesting agent. Another function of the IHA is to receive global snoop requests, issue local snoop requests, collect local snoop responses, consolidate them, and issue a global snoop response to global requester.

The intermediate home and cache agents of the coherency director allow the scalability of the basic multiprocessor assembly 100 of FIG. 1. Applying aspects of the current invention allows multiple instances of the multiprocessor system assembly to be interconnected and share in a cache coherency system. In FIG. 3, intermediate home agents (IHAs) and intermediate cache agents (ICAs) act as intermediaries between cells to arbitrate the use of shared cache lines. System controllers 345 and 395 control logic and sequence events within cells x 310 and Y 380 respectively.

An IHA functions to receive all requests to a given cell. A fairness methodology is used to allows multiple request to be dispatched in a predictable manner that gives nearly equal access opportunity between requests. IHAs are used to determine which remote ICA have a cache line by querying the ICAs under its control. IHAs are used to issue USP requests to ICAs. An IHA may use a local directory to keep track of each cache line for each agent it controls.

An ICA functions to receive and execute requests from IHAs. Here too, a fairness methodology allows a fair servicing of all received requests. Another duty of an ICA is the send out snoop messages to remote IHA that respond back to the ICA and eventually the requesting home agent. The ICA receives global requests from a global requesting agent (IHA), performs a lookup in an RDIR and may issue global snoops and local request to the local home. The snoop response goes directly to the global requesting agent (IHA). The ICA gets the local response and sends it to the global requesting agent. The global requesting agent receives all the responses and determines the final response to the local requester. The other function of the ICA is to receive a local snoop request when the home of a request is local. The ICA does a RDIR lookup and may issue global snoop requests to global agents (IHA). The global agents issue local snoop requests as needed, collect the snoop responses, consolidate them into a single response and send it back to the ICA. The ICA collects the snoop responses, consolidates them and issues a snoop response back to the local home. In one embodiment, the ICA can issue a snoop request back to the local requesting agent. In one aspect of the invention, if an IHA requests a status or line of cache information from an ICA, and the ICA has determined that it cannot respond immediately, the ICA can return a retry indication to the requesting IHA. The requesting IHA then knows to resubmit the request after a determined amount of time. In one aspect of the invention, a deli-ticket style of retry response is provided. Here, a retry response may include a number, such as a time indication, wherein the retry may be performed by the IHA when the number is reached.

If the requested cache line is held in local memory (the home is local) then the requesting agent or home agent sends a snoop request directly to the local ICA. If the requested cache line's home is in a remote cell then the original request is sent to the IHA who then sends the request to the remote ICA of the home cell. The ICA contains the access to the RDIR. The Target ICA (the home ICA) determines if the cache line is owned by a caching agent and the status of the ownership via the RDIR. If the owning agent(s) is in a remote cell (or is a global caching agent) then the RDIR contains an entry for that cache line and its coherency state. The local caching agents are the caching agents that are connected directly to the chip's IHAs. If an RDIR miss occurs or if the cache line status is shared then it is inferred that the local caching agents may have ownership. Upon the occurrence of an RDIR miss, then the local caching agents may have shared, exclusive, or modified ownership status as well as a memory copy. In the event of a shared hit, then a local caching agent might have a shared copy; if exclusive or modified hit then no local agent can have a copy. For some combinations of request type and RDIR status, the original request is sent to the local home and snoop request(s) to global caching agents such as a remote IHA(s).

In one aspect of the invention, an ICA may have a remote directory associated with it. This remote directory can store information relating to which IHA has ownership of the cache that it tracks. This is useful because regular home agents do not store information about which remote home agents has a particular line of cache. As a result having access to a remote directory, ICAs become useful to keep track of the status of remote cache lines.

The information in a remote directory includes 2 bits for a state indication; one of invalid, shared, exclusive, or modified. A remote directory also includes 8 bits of IHA identification and 6 bits of caching agent identification information. Thus each remote directory information may be 16 bits along with a starting address of the requested cache line. Shared memory system may also include an 8 bit presence vector information.

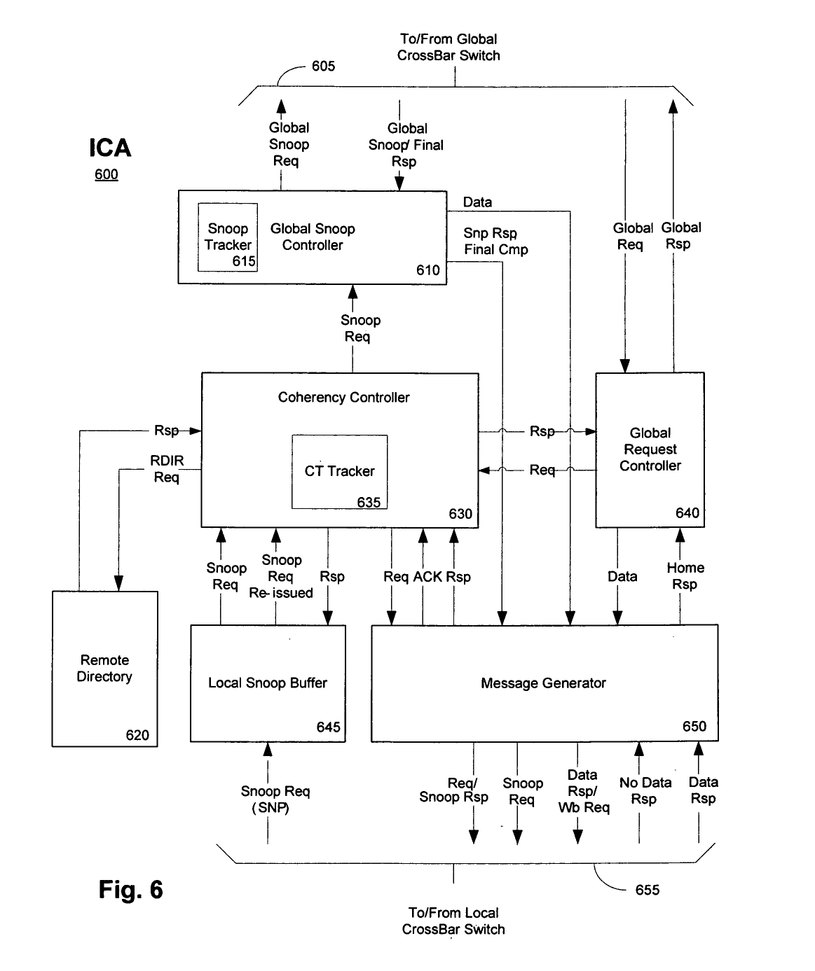

In one embodiment, the RDIR may be sized as follows:
Assuming that the size is based on a 16 MB cache per socket and 64 bits of cache line, then 2²⁴ MB/2⁶ bits per cache line=218 cache lines per socket=256 K cache lines per socket.
Given that there are 4 sockets per cell, then 1 M cache lines per cell. FIG. 6 is a block diagram of an RDIR.
   Shared Microprocessor System

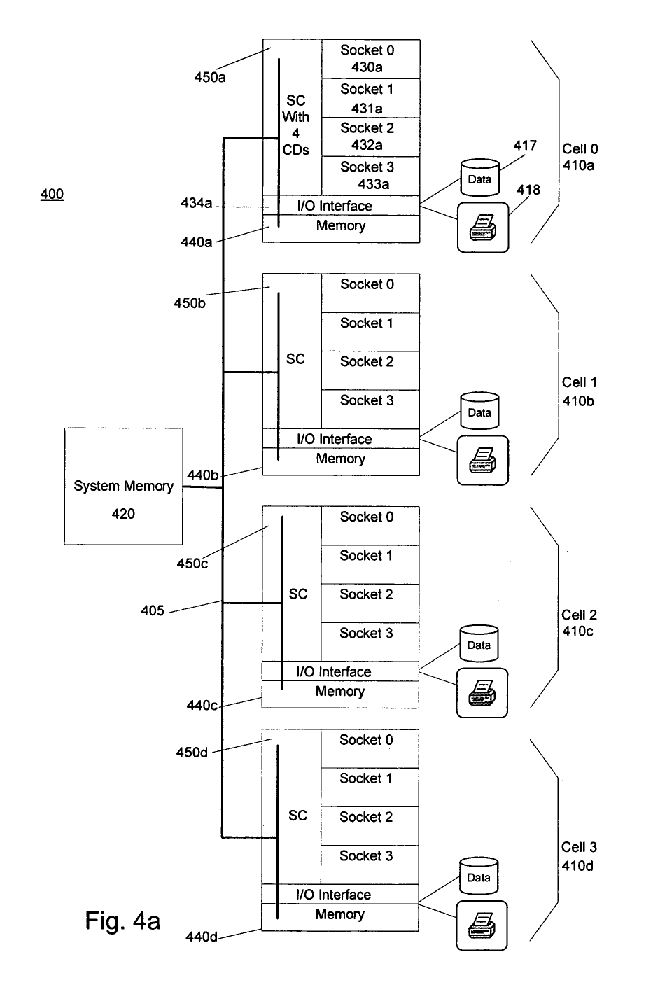

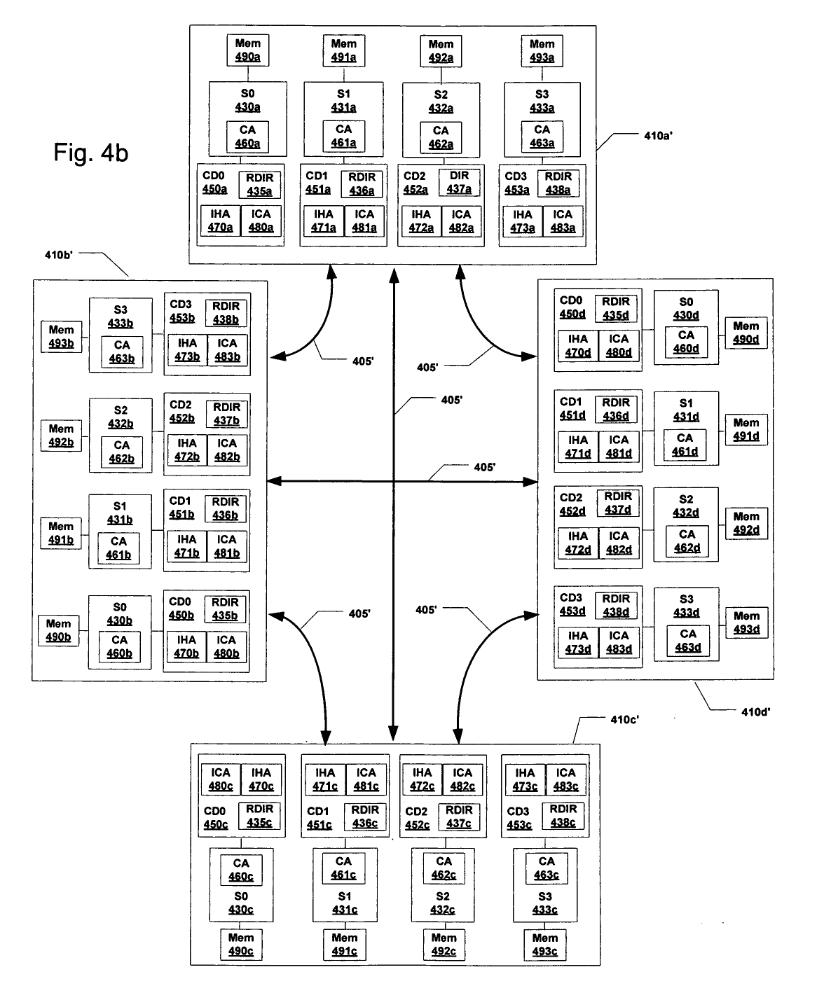

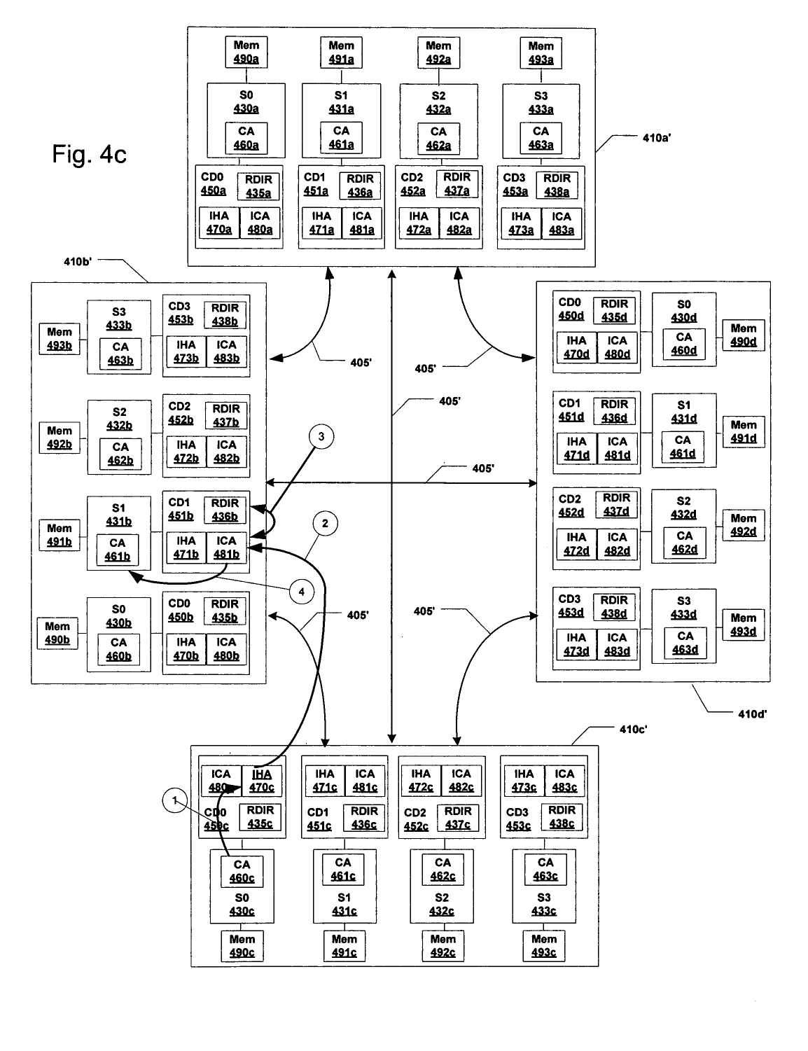

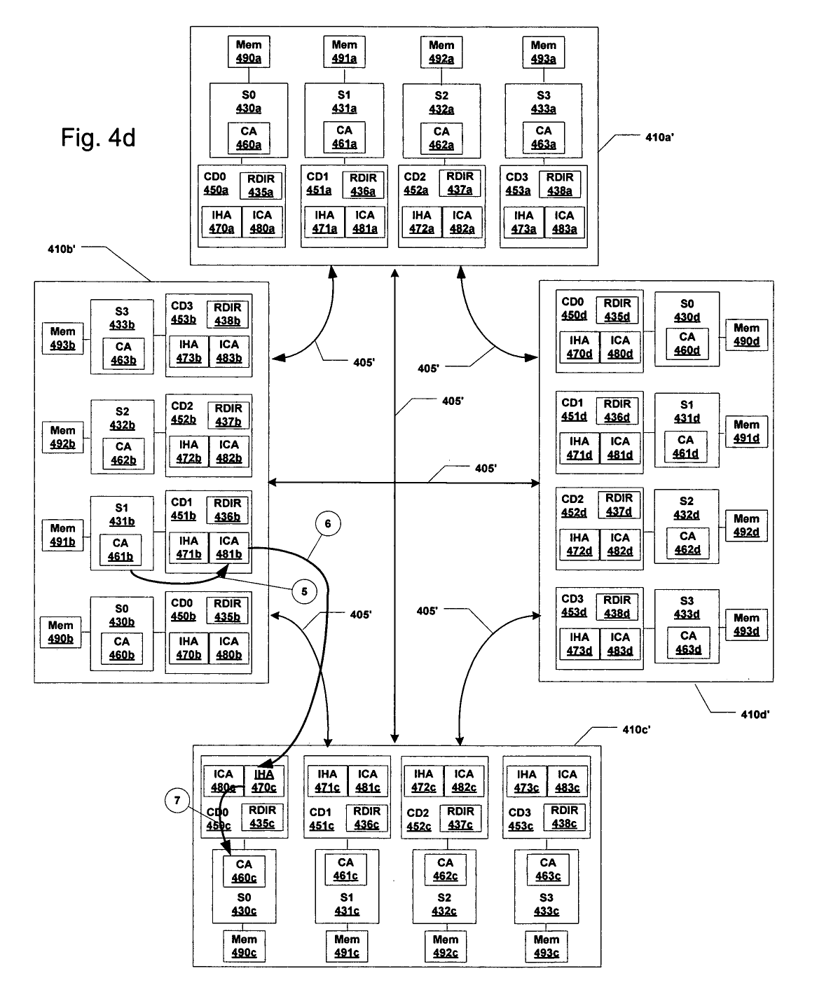

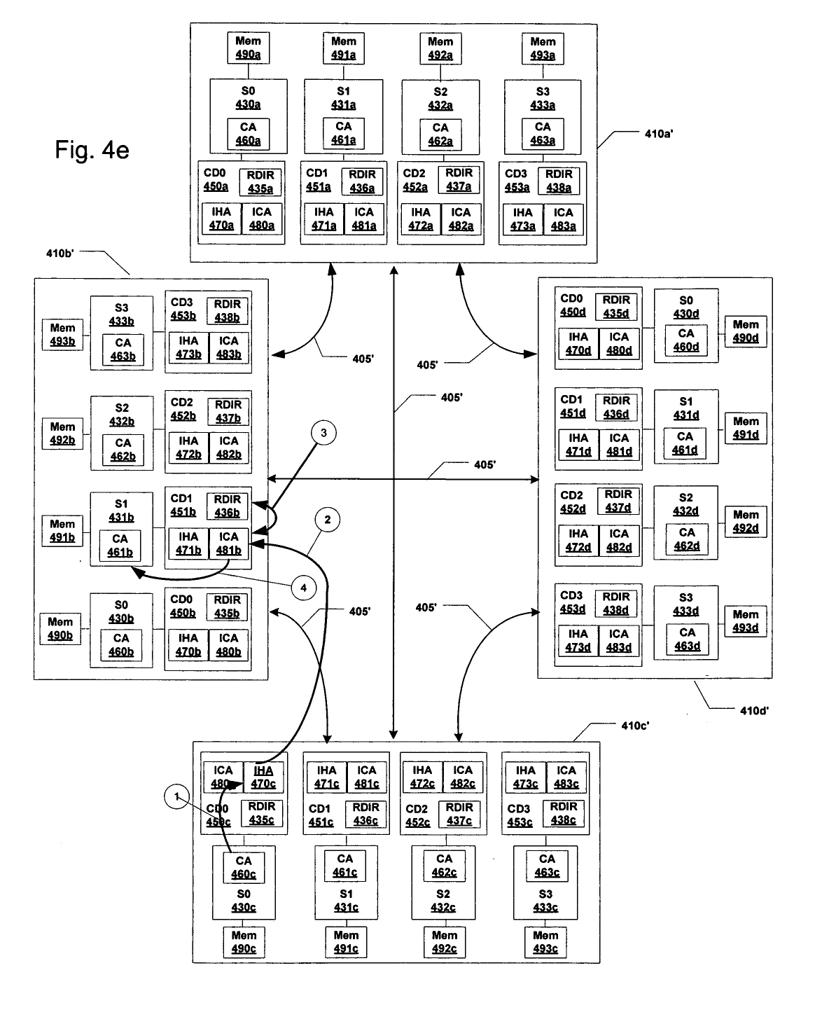

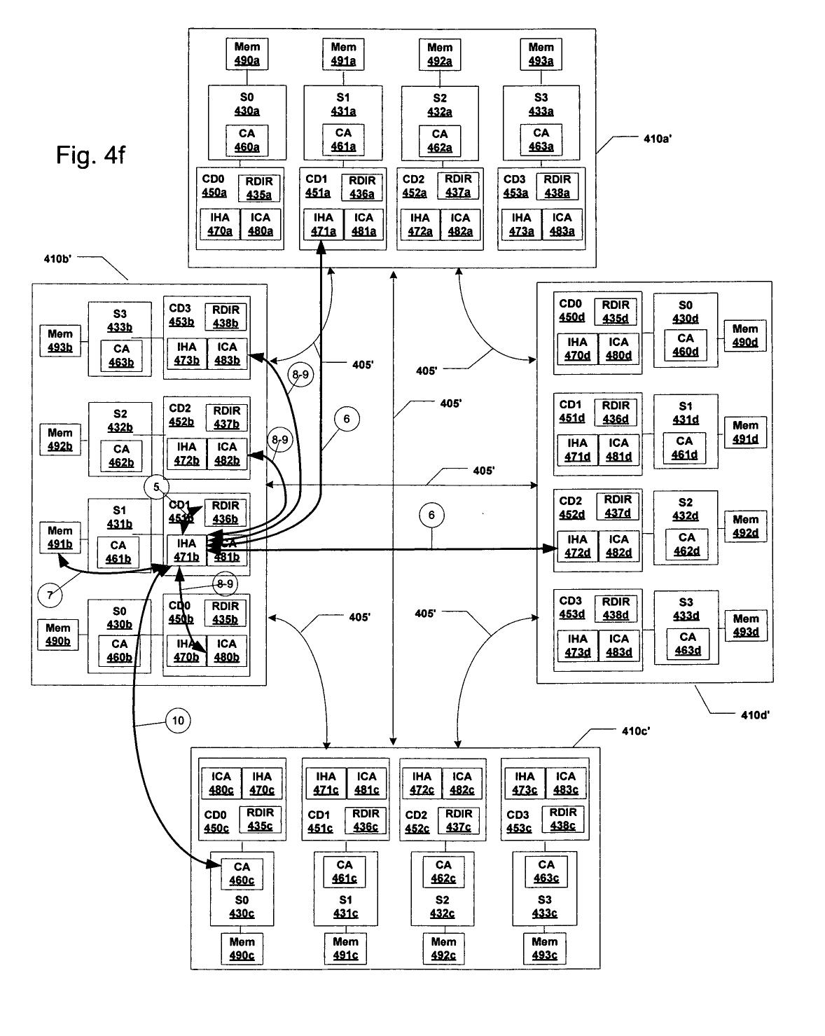

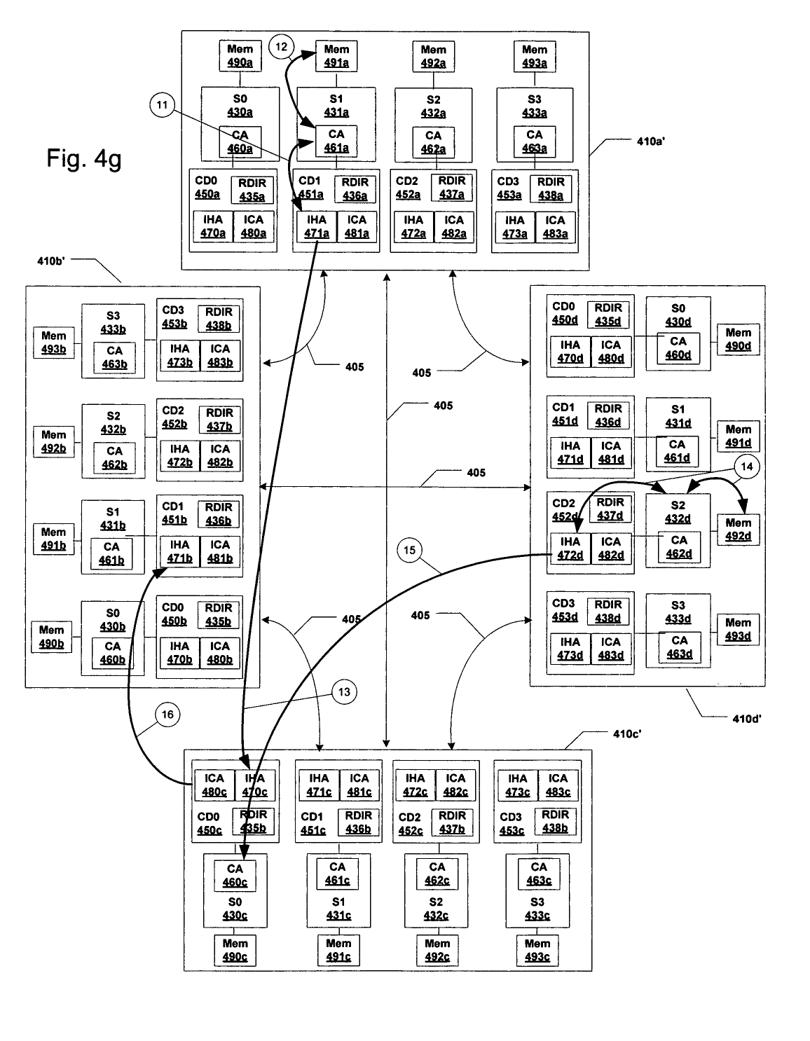

FIG. 4a is a block diagram of a shared multiprocessor system (SMP) 400. In this example, a system is constructed from a set of cells 410a-410d that are connected together via a high-speed data bus 405. Also connected to the bus 405 is a system memory module 420. In alternate embodiments (not shown), high-speed data bus 405 may also be implemented using a set of point-to-point serial connections between modules within each cell 410a-410d, a set of point-to-point serial connections between cells 410a-410d, and a set of connections between cells 410a-410d and system memory module 420.

Within each cell, a set of sockets (socket 0 through socket 3) are present along with system memory and I/O interface modules organized with a system controller. For example, cell 0 410a includes socket 0, socket 1, socket 2, and socket 3 430a-433a, I/O interface module 434a, and memory module 440a hosted within a system controller. Each cell also contains coherency directors, such as CD 450a-450d that contains intermediate home and caching agents to extend cache sharing between cells. A socket, as in FIG. 1, is a set of one or more processors with associated cache memory modules used to perform various processing tasks. These associated cache modules may be implemented as a single level cache memory and a multi-level cache memory structure operating together with a programmable processor. Peripheral devices 417-418 are connected to I/O interface module 434a for use by any tasks executing within system 400. All of the other cells 410b-410d within system 400 are similarly configured with multiple processors, system memory and peripheral devices. While the example shown in FIG. 4 illustrates cells 0 through cells 3 410a-410d as being similar, one of ordinary skill in the art will recognize that each cell may be individually configured to provide a desired set of processing resources as needed.

Memory modules 440a-440d provide data caching memory structures using cache lines along with directory structures and control modules. A cache line used within socket 2 432a of cell 0 410a may correspond to a copy of a block of data that is stored elsewhere within the address space of the processing system. The cache line may be copied into a processor's cache memory by the memory module 440a when it is needed by a processor of socket 2 432a. The same cache line may be discarded when the processor no longer needs the data. Data caching structures may be implemented for systems that use a distributed memory organization in which the address space for the system is divided into memory blocks that are part of the memory modules 440a-440d. Data caching structures may also be implemented for systems that use a centralized memory organization in which the memory's address space corresponds to a large block of centralized memory of a system memory block 420.

The SC 450a and memory module 440a control access to and modification of data within cache lines of its sockets 430a-433a as well as the propagation of any modifications to the contents of a cache line to all other copies of that cache line within the shared multiprocessor system 400. Memory-SC module 440a uses a directory structure (not shown) to maintain information regarding the cache lines currently in used by a particular processor of its sockets. Other SCs and memory modules 440b-440d perform similar functions for their respective sockets 430b-430d.

One of ordinary skill in the art will recognize that additional components, peripheral devices, communications interconnections and similar additional functionality may also be included within shared multiprocessor system 400 without departing from the spirit and scope of the present invention as recited within the attached claims. The embodiments of the invention described herein are implemented as logical operations in a programmable computing system having connections to a distributed network such as the Internet. System 400 can thus serve as either a stand-alone computing environment or as a server-type of networked environment. The logical operations are implemented (1) as a sequence of computer implemented steps running on a computer system and (2) as interconnected machine modules running within the computing system. This implementation is a matter of choice dependent on the performance requirements of the computing system implementing the invention. Accordingly, the logical operations making up the embodiments of the invention described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto.

FIGS. 4b-4c depict the SMS of FIG. 4a with some modifications to detail some example transactions between cells that seek to share one or more lines of cache. One characteristic of a cell, such as in FIG. 4a, is that all or just one of the sockets in a cell may be populated with a processor. Thus, single processor cells are possible as are four processor cells. The modification from cell 410a in FIG. 4a to cell 410a′ in FIG. 4b is that cell 410a′ shows a single populated socket and one CD supporting that socket. Each CD having an ICA, an IHA, and a remote directory. In addition, a memory block is associated with each socket. The memory may also be associated with the corresponding CD module. A remote directory (RDIR) module in the CD module may also be within the corresponding socket and stored within the memory module. Thus, example cell 410a′ contains four CD's, CD0 450a, CD1 451a, CD2, 452a, CD3 453a each having a corresponding DIR, IHA and ICA, communicating with a single socket and cashing agent within a multiprocessor assembly and an associated memory.

In cell 410a′, CD0 450a contains IHA 470a, ICA 480a, remote directory 435a. CD0 450a also connects to an assembly containing cache agent CA 460a, and socket S0 430a which is interconnected to memory 490a. CD1 451a contains IHA 471a, ICA 481a, remote directory 435a. CD1 451a also connects to an assembly containing cache agent CA 461a, and socket S1 431a which is interconnected to memory 491a. CD2 452a contains IHA 472a, ICA 482a, remote directory 436a. CD1 452a also connects to an assembly containing cache agent CA 462a, and socket S2 432a which is interconnected to memory 492a. CD2 452a contains IHA 472a, ICA 482a, remote directory 437a. CD2 452a also connects to an assembly containing cache agent CA 462a, and socket S2 432a which is interconnected to memory 492a. CD3 453a contains IHA 473a, ICA 483a, remote directory 438a. CD3 453a also connects to an assembly containing cache agent CA 463a, and socket S3 433a which is interconnected to memory 493a.

In cell 410b′, CD0 450b contains IHA 470b, ICA 480b, remote directory 435b. CD0 450b also connects to an assembly containing cache agent CA 460b, and socket S0 430b which is interconnected to memory 490b. CD1 451b contains IHA 471b, ICA 481b, remote directory 435b. CD1 451b also connects to an assembly containing cache agent CA 461b, and socket S1 431b which is interconnected to memory 491b. CD2 452b contains IHA 472b, ICA 482b, remote directory 436b. CD1 452b also connects to an assembly containing cache agent CA 462b, and socket S2 432b which is interconnected to memory 492b. CD2 452b contains IHA 472b, ICA 482b, remote directory 437b. CD2 452b also connects to an assembly containing cache agent CA 462b, and socket S2 432b which is interconnected to memory 492b. CD3 453b contains IHA 473b, ICA 483b, remote directory 438b. CD3 453b also connects to an assembly containing cache agent CA 463b, and socket S3 433b which is interconnected to memory 493b.

In cell 410c′, CD0 450c contains IHA 470c, ICA 480c, remote directory 435c. CD0 450c also connects to an assembly containing cache agent CA 460c, and socket S0 430c which is interconnected to memory 490c. CD1 451c contains IHA 471c, ICA 481c, remote directory 436c. CD1 451c also connects to an assembly containing cache agent CA 461c, and socket S1 431c which is interconnected to memory 491c. CD2 452c contains IHA 472c, ICA 482c, remote directory 437c. CD1 452c also connects to an assembly containing cache agent CA 462c, and socket S2 432c which is interconnected to memory 492c. CD2 452c contains IHA 472c, ICA 482c, remote directory 437c. CD2 452c also connects to an assembly containing cache agent CA 462c, and socket S2 432c which is interconnected to memory 492c. CD3 453c contains IHA 473c, ICA 483c, remote directory 438c. CD3 453c also connects to an assembly containing cache agent CA 463c, and socket S3 433c which is interconnected to memory 493c.

In cell 410d′, CD0 450d contains IHA 470d, ICA 480d, remote directory 435d. CD0 450d also connects to an assembly containing cache agent CA 460d, and socket S0 430d which is interconnected to memory 490d. CD1 451d contains IHA 471d, ICA 481d, remote directory 436d. CD1 451d also connects to an assembly containing cache agent CA 461d, and socket S1 431d which is interconnected to memory 491d. CD2 452d contains IHA 472d, ICA 482d, remote directory 437d. CD1 452d also connects to an assembly containing cache agent CA 462d, and socket S2 432d which is interconnected to memory 492d. CD2 452d contains IHA 472d, ICA 482d, remote directory 437d. CD2 452d also connects to an assembly containing cache agent CA 462d, and socket S2 432d which is interconnected to memory 492d. CD3 453d contains IHA 473d, ICA 483d, remote directory 438d. CD3 453d also connects to an assembly containing cache agent CA 463d, and socket S3 433d which is interconnected to memory 493d.

In one embodiment of FIG. 4b, a high speed serial (HSS) bus 405′ is shown as a set of point to point connection but one of skill in the art will recognize that the point to point connections may also be implemented as a bus common to all cells. It is also noted that the processors in cells which reside in sockets may be processors of any type that contains local cache and have a multi level cache structure. Any socket may have one or more processors. In one embodiment of FIG. 4b, the address space of the SMS 400 is distributed across all memory modules. In that embodiment, memory modules within a cell are interleaved in that the two LSBs of address select memory line in one of four memory modules in the cell. In an alternate configuration, the memory modules are contiguous memory blocks of memory. As indicated in FIG. 4a, cells may have I/O modules and an additional a ITA module (intermediate tracker agent) which manages I/O data (non-cache coherent) data read/writes.

FIGS. 4c and 4d depict a typical communication exchange between cells where a line if cache is requested that has no shared owners. Thus, FIGS. 4c and 4d have the same reference designations for cell elements. The communication requests are deemed typical based on the actual sharing of lines of cache among the entire four cell configuration of FIG. 4b. Because any particular line of cache may be shared among different cells in a number of different modes (MESI; modified, exclusive, shared, and invalid), the communications between cells depends on the particular mode of cache sharing that the shared line of cache possesses when a request is made by a requesting agent. Although point to point interconnections 405′ are used in FIG. 4b to communicate from cell to cell, the transactions described below are indicted by arrows whose endpoints designate the source and destination of a particular transaction. The transactions are numbered via balloon number designations to differentiate them from designations of the elements of any particular cell or bus element.

In FIG. 4c, the requesting agent is the socket 430c having caching agent CA 460c of cell 410c′. CA 460c in cell 410c′ requests a line of cache data from an address that is no immediately available to the socket 430c. Transaction 1 represents the original cache line request from multiprocessor component assembly socket 430c having caching agent CA 460c in cell 410′. The original cache line request is sent to IHA 470c of CD0 450c. This request is an example of an original request for a line of cache that is outside of the multiprocessor component assembly which contains CA 460c and socket 430c. The IHA 470c consults the RDIR 435c and determines that CD0 450c is not the home of the line of cache requested by CA 460c. Stated differently, there is no local home for the requested line of cache. In this instance, it is determined that memory 491b in cell 410b′ is the home of the requested line of cache by reading RDIR 435c. It is noted that ICA 481b in cell 410b′ services memory 491b which owns the desired line of cache. In transaction 2, IHA 470c then sends a request to ICA 481b of cell 410b′ to acquire the data (line of cache). At the home ICA 481b, the RDIR 436b is consulted in transaction 3 and it is determined that the requested line of cache is not shared and only mem 491b has the line of cache. Transaction 4 depicts that the line of cache in mem 491b is requested via the CA 461b.

Referring now to FIG. 4d, in transaction 5, CA 461b retrieves the line of cache from mem 491b and sends it to ICA 481b. IHA 471b accesses the directory RDIR 436b to determine the status of the cache line ownership. In transaction 6, ICA 481b then sends a cache line response to IHA 470c of cell 410c′. In transaction 7, ICA 481b returns retrieved cache line and combined snoop responses to the requesting agent CA 460c in cell 410c′ using the IHA 470c in cell 410c′ as the receiver of the information.

The transactions 1-7 shown in FIGS. 4b through 4d are typical of a request for a line of cache whose home is outside of the requesting agent's cell and whose cache line status indicates that the cache line is not shared with other agents of different cells. A similar set of transactions may be encountered when the desired line of cache is outside of the requesting agent's cell and the line of cache is shared. This is, the desired line of cache is read only. In this situation, the transactions are similar except that the directory 436b in cell 410b′ indicates a shared cache line state. After the line of cache is provided to back to the requesting agent as in transaction 6 of FIG. 4d, the directory 436b is updated to include the requesting cell as also having a copy of the shared and read only line of cache. In a different scenario, a line of cache can be sought which is desired to be exclusive, yet the line of cache is shared among multiple agents and cells. This example is presented in the transactions of FIGS. 4e through 4g.

FIGS. 4e, 4f, and 4g depict typical a typical communication exchange between cells that can result from the request of an exclusive line of cache from the requesting agent CA 460c of FIG. 4b. Thus, FIGS. 4e, 4d, and 4e have the same reference designations for cell elements. The communication requests are deemed typical based on the actual sharing of lines of cache among the entire four cell configuration of FIG. 4b. Because any particular line of cache may be shared among different cells in a number of different modes (MESI; modified, exclusive, shared, and invalid), the communications between cells depends on the particular mode of cache sharing that the shared line of cache possesses when a request is made by a requesting agent. Although point to point interconnections 405′ are used in FIG. 4b to communicate from cell to cell, the transactions described below are indicted by arrows whose endpoints designate the source and destination of a particular transaction. The transactions of FIGS. 4e through 4g are numbered via balloon number designations to differentiate them from designations of the elements of any particular cell or bus element.

Beginning with FIG. 4e, CA 460c in cell 410c′ requests an exclusive line of cache data from an address that is shared between the processors in the cells of FIG. 4b. Transaction 1 originates from socket 430c in the multiprocessor component assembly which includes caching agent CA 460c in cell 410′. The original request is sent to IHA 470c of CD0 450c. This request is an example of an original request for a line of cache that is outside of the multiprocessor component assembly which contains CA 460c and socket 430c. The IHA 470c consults the RDIR 435c and determines that CD0 450c is not the home of the line of cache requested by CA 460c. Thus, there is no local home for the exclusive requested line of cache. In this instance, memory 491b in cell 410b′ is the home of the requested line of cache and transaction 2 is directed to ICA 481b that services memory 491b. At the home ICA 481b, the DIR 436b is consulted in transaction 3 and it is determined that the requested line of cache is shared and that a copy also resides in mem 491b. The shared copies are owned by sockets 432d in cell 410d′ and socket 431a in cell 410a′. Transaction 4 depicts that the copy of the line of cache in mem 491b is retrieved via the CA 461b.

Referring now to FIG. 4f, in transaction 5, IHA 471b accesses the directory RDIR 436b to determine the status of the cache line ownership. In this case, the ownership appears as shared between Cells 410b′, 410a′, and cell 410d′. In transaction 6, IHA 471b then sends a cache line request to IHA 472d of cell 410d′ and to IHA 471a of cell 410a′. In transaction 7, IHA 471b of cell 410b′ retrieves the requested Cache Line from memory 491b of the same cell. In transaction 8, as a result of the request for the line of cache, ICA 481b of cell 410b′ sends out a snoop request to the other CDs of the cell. Thus, ICA 481b sends out snoop requests to ICA 480b, ICA 482b, and ICA 483b of cell 410b′. In transaction 9, those ICAs return a snoop response to IHA 471b which collects the responses. In transaction 10, IHA 471b returns retrieved cache line and combined snoop responses to the requesting agent CA 460c in cell 410c′ using the IHA 470c in cell 410c′ as the receiver of the information.

Referring now to FIG. 4g, in transaction 10, IHA 471a of cell 410a′ sends a cache line request to retrieve the desired cache line from CA 461a. In transaction 11, CA 461a retrieves the requested line of cache from Memory 491a of cell 410a′. This transaction is a result of the example instance of the shared line of cache being present in cells 410a′ and 410d′ as well as in cell 410b′. In transaction 13, IHA 471a forwards the cache line found in memory 491a of cell 410a′ to IHA 470c of cell 410c′. A similar set of events unfolds in cell 410d′. In transaction 14, IHA 472d of cell 410d′ sends cache line request to retrieve a cache line from CA 462d and memory 492d of cell 410d′. In transaction 15, IHA 472d of cell 410d′ forwards the cache line from memory 492d to the requesting caching agent CA 460c in cell 410c′ using CD0 450c.

At this point in the transactions, the requesting agent CA 460c in cell 410c′ has received all of the cache line responses from 410a′ , 410b′ and cell 410d′. The status of the requested line of cache that was in the other cells is invalidated in those cells because they have given up their copy of the cache line. At this point, it is the responsibility of the requesting agent to sift through the responses from the other cells and select the most current cache line value to use. After all responses are gathered, a completion response is sent via transaction 16 which informs the home cell that there are no more transactions to be expected with regard to the specific line of cache just requested. Then, a next set of new transactions can then be initiated based on a next cache line request from any suitable requesting agent in the FIG. 4b configuration. Alternatives to the scenario described in FIGS. 4b-d occur often based on the ownership characteristics of the requested line of cache.

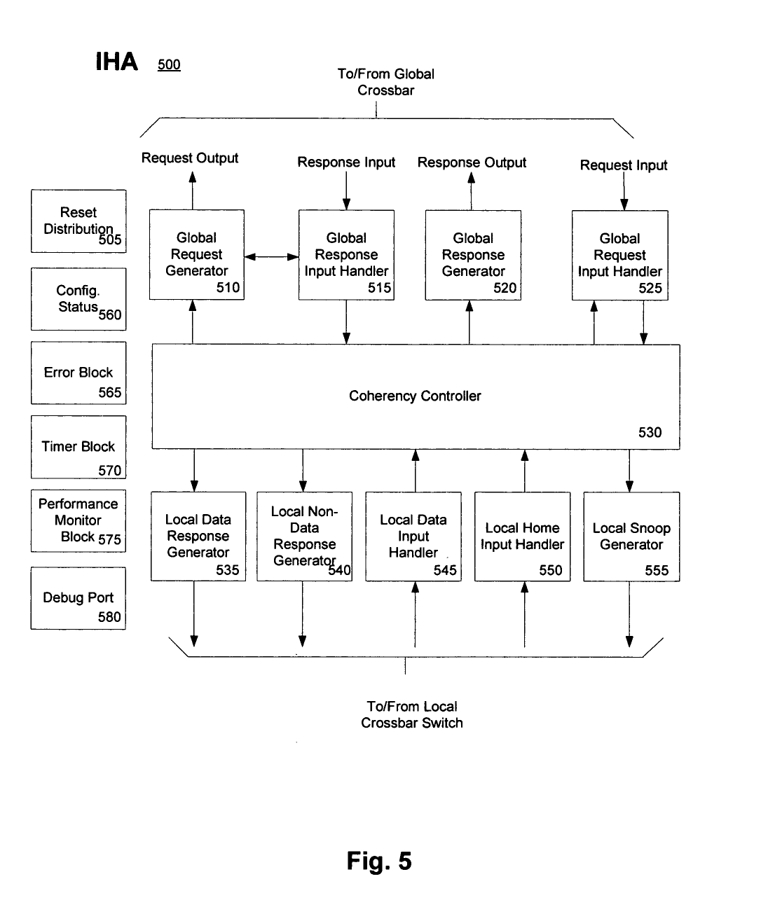

FIG. 5 illustrates one embodiment of an intermediate home agent 500. In this embodiment, a global request generator 510, a global response input handler 515, a global response generator 520, and a global request input handler 525 all have connection to a global crossbar switch similar to the one depicted in FIG. 3. The local data response generator 535, the local non-data response generator 540, the local data input handler, and the local home input handler 550, and the local snoop generator 555 all have connection to local cross bar switch similar to the one depicted in FIG. 3. This local cross bar switch interface allows connection to a processor director and a multiprocessor component assembly item such as in FIG. 3. The above referenced request and response generators and handlers are connected to a central coherency controller 530.

The global request generator 510 is responsible for issuing global requests on behalf of the Coherency Controller (CC) 530. The global request generator 510 issues Unisys Scalability Protocol (USP) requests such as original cache line requests to other cells. The global request generator 510 provides a watch-dog timer that will insure that if it has any messages to send on the request interface, that it eventually transmits them to make forward progress. The global response input handler 515 receives responses from cells. For example, if an original request was sent for a line of cache from another cell in a system, them the global response input handler 515 is the functionality that receives the response from the responding cell. The global response input handler (RSIH) 515 is responsible for collecting all responses associated with a particular outstanding global request that was issued by the CC 530. The RSIH attempts to coalesce the responses and only sends notifications to the CC when a response contains data, or when all the responses have been received for a particular transaction, or when the home or early home response is received and indicates that a potential local snoop may be required. The RSIH also provides a watch-dog timer insures that if it has started receiving a packet from a remote cell, that it will eventually receive all portions of the packet, and hence make forward progress. The global response generator (RSG) 520 is responsible for generating responses back to an agent the requests cache line information. One example of this is the response provide by a RSG in the transmission of responses to snoop requests for lines of cache and for collections of data to be sent to a remote requesting cell. The RSG will provide a watch-dog timer that will insure that if it has any responses to send on the USP response interface, that it eventually sends them to make forward progress. The Global Request Input Handler 525 (RQIH) is responsible for receiving Global USP Snoop Requests from the Global Crossbar Request Interface and passing them to the CC 530. The RQIH also examines and validates the request for basic errors, extracts USP information that needs to be tracked, and converts the request into the format that the CC can use.

The local data response generator 535 (LDRG) is responsible for interfacing the Coherency Controller 530 to the local crossbar switch for the purpose of sending the home data responses to the multiprocessor component assembly (reference FIG. 3). The LDRG takes commands and data from the coherency controller and creates the appropriate data response packet to send to the multiprocessor component assembly via the local crossbar switch. The Local Non-Data Response Generator 540 (LNRG) is responsible for interfacing the coherency controller 530 to the local crossbar switch for the purpose of sending home status responses to the multiprocessor component assembly (reference FIG. 3). The Local Non-Data Response Generator 540 (LNRG) takes commands from the coherency controller 530 and creates the appropriate non-data response packet to send to the multiprocessor component assembly via the local crossbar switch. The Local Data Input Handler 545 (LDIH) is responsible for interfacing the local crossbar switch to the coherency controller 530. This includes performing the necessary checks on the received packets from the multiprocessor component assembly via the local crossbar switch to insure that no obvious errors are present. The LDIH sends data responses from a socket in a multiprocessor component assembly to the coherency controller 530. Additionally, the LDIH also acts to accumulate data sent to the coherency controller 530 from the multiprocessor assembly. The Local Home Input Handler 550 (LHIH) is responsible for interfacing the local crossbar switch to the coherency controller 530. The LHIH performs the necessary checks on the received compressed packets from a socket in the multiprocessor assembly to insure that no obvious errors are present. One example packet is an original request from a socket to obtain a line of cache from another cache line owner in another cell. The local snoop generator 555 (LSG) is responsible for interfacing the coherency controller 530 to the local crossbar switch for the purpose of sending snoop requests to caching agents in a multiprocessor component assembly. The LSG takes commands from the coherency controller 530, and generates the appropriate snoop requests and routes them to the correct socket via the cross bar switch.

The coherency controller 530 (CC) functions to drive and receive information to and from the global and local interfaces described above. The CC is comprised of a control pipeline and a data pipeline along with state machines that co-ordinates the functionality of an IHA in a shared multiprocessor system (SMS). The CC handles global and local requests for lines of cache as well as global and local responses. Read and write requests are queued and handled to that all transactions into and out of the IHA are addressed even in times of heavy transaction traffic.

Other functional blocks depicted in FIG. 5 include blocks that provides services to the global and local interface blocks as well as the coherency controller. A reset distribution block 505 (RST) is responsible for registering the IHA's reset inputs and distributing them to all other blocks in the IHA. The RST handles both cold and warm reset modes. The configuration status block 560 (CSR) is responsible for instantiating and maintaining configuration registers for the IHA 500. The error block 565 (ERR) is responsible for collecting errors in the IHA core and reporting, reading, and writing to the error registers in the CSR. The timer block 570 (TMR) is responsible for generating periodic timing pulses for each watchdog timer in the IHA 500 as well as other basic timing functions within the IHA 500. The performance monitor block 575 (PM) generates statistics on the performance of the IHA 500 useful to determine if the IHA is functioning efficiently with a system. The debug port 580 provides the high level muxing of internal signals that will be made visible on pins of the ASIC which includes the IHA 500. This port provides access to characteristic signals that can be monitored in real time in a debug environment.

FIG. 6 depicts one embodiment of an intermediate caching agent (ICA) 600. The ICA 600 accepts transactions from the global cross bar switch interface 605 to the global snoop controller 610 and the global request controller 640. the local cross bar interface 655 to and from the ICA 600 is accommodated via a local snoop generator 645 and a message generator 650. The coherency controller 630 performs the state machine activities of the ICA 600 and interfaces to a remote directory 620 as well as the global and local interface blocks previously mentioned.

The global request controller 640 (GRC) functions to interface to the global original requests from the global cross bar switch 605 to the coherency controller 630 (CC). The GRC implements global retry functions such as the deli counter mechanism. The GRC generates retry responses based on input buffer capability a retry function, and conflicts detected by the CC 630. Original remote cache line requests are received via the global cross bar interface and original responses are also provided back via the GRC 640. The function of the global snoop controller 610 (GSC) is to receive and process snoop requests from the CC 630. These snoop requests are generated for both local and global interfaces The GSC 610 connects to the global cross bar switch interface 605 and the message generator 650 to accommodate snoop requests and responses. The GSC also contains a snoop tracker to identify and resolve conflicts between the multiple global snoop requests and responses transacted by the GSC 610.

The function of the local snoop buffer 645 (LSB) is to interface local snoop requests generated by a multiprocessor component assembly socket via the local cross bar switch. The LSB 645 buffers snoop requests that conflict or need to be ordered with the current requests in the coherency controller 630. The remote directory 620 (RDIR) functions to receive lookup and update requests from the CC 630. Such requests are used to determine the coherency status of local cache lines that are owned remotely. The RDIR generates responses to the cache line status requests back to the CC 630. The coherency controller 630 (CC) functions to process local snoop requests from LSB 645 and generate responses back to the LSB 645. The CC 630 also processes requests from the GRC 640 and generates responses back to the GRC 640. The CC 630 performs lookups to the RDIR 620 to determine the state of coherency in a cache line and compares that against the current entries of a coherency track 635 (CT) to determine if conflicts exist. The CT 635 is useful to identify and prevent deadlocks between transactions on the local and global interfaces. The CC 630 issues requests to the GSC to issue global snoop requests and also issues requests to the message generator (MG) to issue local requests and responses. The message generator 650 (MG) is the primary interface to the local cross bar interface 655 along with the Local Snoop Buffer 645. The function of the MG 650 is to receive and process requests from the CC 630 for both local and global transactions. Local transactions interface directly to the MG 650 via the local cross bar interface 655 and global transactions interface to the global cross bar interface 605 via the GRC 640 or the GSC 610.

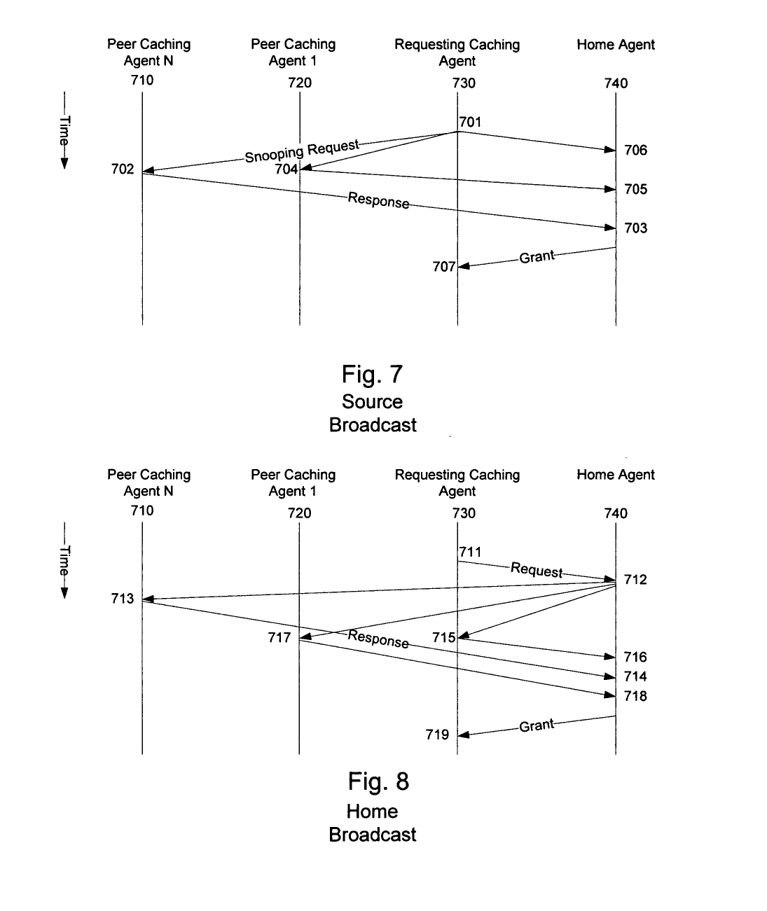

The Unisys® Scalability Protocol (USP) is a protocol that allows one processor assembly or socket, such as 430a-433a in FIG. 4, to communicate with other processor assemblies to resolve the state of lines of cache. FIG. 7 is one type of timing that may be used in the USP. In FIG. 7, there are assumed a requesting agent (such as a caching agent associated with CD 450 in FIG. 4), a home agent associated with CD 450b in FIG. 4, and multiple peer caching agents (such as caching agents in CD 450c and 450d in FIG. 4. Referring to FIG. 7, in a source broadcast type of transaction, the requesting caching agent 730 sends out a request at time 701 to all agents to determine the statues of a line of cache. The request, called a snooping request, may be sent to peer caching agent N 710. A response from peer caching agent N 710 is sent at time 702 and is received at the home agent 740 at time 703. Likewise, a snoop request is sent from the requesting agent 730 at time 701 and is received by peer caching agent 1 (720) at time 704. A response sent at time 704 is received at the home agent 740 at time 705. Also, a snoop request is sent from the requesting agent 730 at time 701 and is received by home agent at time 706. The responses are assessed by the home agent and a grant may be given from the home agent 740 to be received by the requesting caching agent 730 at time 707. In a source broadcast, the requesting source sends out the broadcast requests and the home agent receives the results and processes the grant to the requesting agent.

In an alternate timing scheme, a home agent based broadcast may be used. FIG. 8 depicts the timing for a home broadcast. Here, the requesting agent 730 at time 711 makes one request the home agent 740. At time 712, the home agent sends out the broadcast requests to all other agents. The home agent 740 makes a request to peer caching agent N 710 which then initiates a response at time 713 back to the home agent 740, received at time 714. The home agent 740 makes a request to the requesting agent 730 which then initiates a response at time 715 back to the home agent 740, received at time 716. The home agent 740 makes a request to peer caching agent 1 720 which then initiates a response at time 717 back to the home agent 740, received at time 718. The home agent 740 then may process the requests and provide a grant to requesting caching agent 730, received at time 719.

In one aspect of the invention, an intermediate caching agent (ICA) receiving a request for a line of cache, checks the remote directory (RDIR) to determine if the requested line of cache is owned by another remote agent. If it is not, then the ICA can respond with an invalid status indicating that the line of cache is available for the requesting intermediate home agent (IHA). If the line of cache is available, the ICA can grant permission to access the line of cache. Once the grant is provided, the ICA updates the remote directory so that future requests by either local agents or remote agents will encounter correct line of cache status. If the line of cache is in use by a remote entity, then a record of that use is stored in the remote directory and is accessible to the ICA.

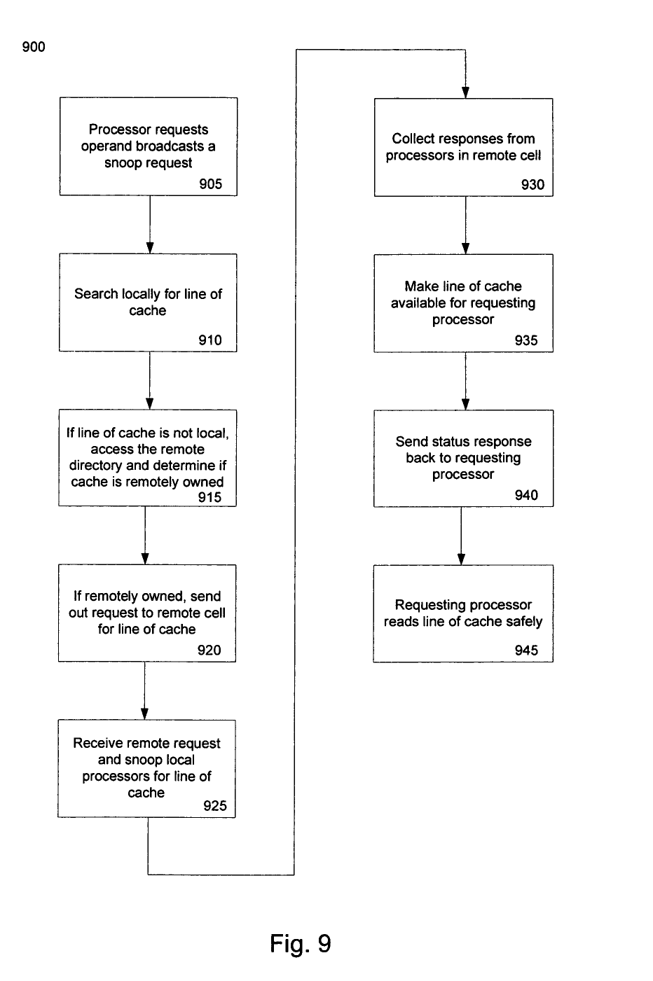

FIG. 9 is a flow diagram of a process having aspects of the invention. Reference to functional blocks in FIG. 3 will also be provided. In the flow 900, a processor M in assembly 330 requiring a cache line which is not in its local caches broadcasts a snoop request to the other processors N, O, and P in its processor assembly 330 (step 905). Each processor determines if the cache line is held in one of its caches by searching (step 910) for the line of cache. Each of the entities receiving the snoop request responds to the requesting processor. Each processor provides a response to the request including the state of the cache line using the standard MESI status indicators. The request provides a immediate response if there are no remote owners.

If no clear ownership response is found via a local search for the cache line among the local processors in the processor assembly 330, the SC 390 of the cell 310 steers the request to the address interleaved CD 340 where the remote directory 320 is accessed (step 915). The lookup in the RDIR 310 reveals any remote owners of the requested cache line. If the cache line is checked out by a remote entity, then the cache line request is routed to the intermediate home agent 350 which sends the request (step 920) to the remote cell indicated by the RDIR 320 information. The intermediate home agent 350 sends the cache line request to the intermediate caching agent 362 of the remote cell 380 via high speed, inter-cell link 355.

Once the remote request for a cache line is received by the ICA 362 of cell 380, then the ICA requests the IHA 352 to find the requested line of cache. The IHA 352 snoops the local processors Q, R, S, and T of processor assembly 332 to determine the ownership status of the requested line of cache (step 925). Each processor responds to the request back to the IHA 352.

The SC 392, which directs the coherency activities of the elements in the cell 380, acts to collect the responses and form a single combined response (step 930) from the IHA 352 to the ICA 362 to send back to the IHA 350 of the requesting cell 310. At this time, if a remote processor has control over a line of cache, such as for example, an exclusive type of control, it may release the line of cache and change the availability status (step 935). The IHA 352 of the cell Y then passes the information back to the IHA 360 and eventually to the requesting processor M (step 940) in assembly 330 of cell X. Since the requested line of cache had an exclusive status and now has an invalid status, the RDIR 320 may be updated. The line of cache may then be safely and reliably read by processor M. (step 945).

The access or remote calls from a requesting cell is accomplished using the Unisys® Scalability Protocol (USP). This protocol enables the extension of a cache managements system from one processor assembly to multiple processor assemblies. Thus, the USP enables the construction of very large systems having a collectively coherent cache management system. The USP will now be discussed.

The Unisys Scalability Protocol (USP) defines how the cells having multiprocessor assemblies communicate with each other to maintain memory coherency in a large shared multiprocessor system (SMP). The USP may also support non-coherent ordered communication. The USP features include unordered coherent transactions, multiple outstanding transactions in system agents, the retry of transactions that cannot be fully executed due to resource constraints or conflicts, the treatment of memory as writeback cacheable, and the lack of bus locks.

In one embodiment, the Unisys Scalability Protocol defines a unique request packet as one with a unique combination of the following three fields:
SrcSCID[7:0]—Source System Controller Identifier (ID)
SrcFuncID[5:0]—Source Function ID
TxnID[7:0]—Transaction ID
Additionally, the Unisys Scalability Protocol defines a unique response packet as one with a unique combination of the following three fields:
DstSCID[7:0]—Destination System Controller ID
DstFuncID[5:0]—Destination Function ID
TxnID[7:0]—Transaction ID

Agents may be identified by a combination of an 8 bit SC ID and a 6 bit Function ID. Additionally, each agent may be limited to having 256 outstanding requests due to the 8 bit Transaction ID. In another embodiment, this limit may be exceeded if an agent is able to utilize multiple Function IDs or SC IDs.

In one embodiment, the USP employs a number of transaction timers to enable detection of errors for the purpose of isolation. The requesting agent provides a transaction timer for each outstanding request. If the transaction is complete prior to the timer expiring, then the timer is cleared. If a timer expires, the expiration indicates a failed transaction. This is potentially a fatal error, as the transaction ID cannot be reused, and the transaction was not successful. Likewise, the home or target agent generally provides a transaction timer for each processed request. If the transaction is complete prior to the timer expiring, then the timer is cleared. If a timer expires, this indicates a failed transaction. This is may be a fatal error, as the transaction ID cannot be reused, and the transaction was not successful. A snooping agent preferentially provides a transaction timer for each processed snoop request. If the snoop completes prior to the timer expiring, then the timer is cleared. If a timer expires, this indicates a failed transaction. This is potentially a fatal error, as the transaction ID cannot be reused, and the transaction was not successful. In one embodiment, the timers may be scaled such that the requesting agent's timer is the longest, the home or target agent's timer is the second longest, and the snooping agent's timer is the least longest.

In one embodiment, the coherent protocol may begin in one of two ways. The first is a request being issued by a GRA (Global Requesting Agent) such as an IHA. The second is a snoop being issued by a GCHA (Global Coherent Home Agent) such as the ICA. The USP assumes all coherent memory to be treated as writeback. Writeback memory allows for a cache line to be kept in a cache at the requesting agent in a modified state. No other coherent attributes are allowed, and it is up to the coherency director to convert any other accesses to be writeback compatible. The coherent requests supported by the USP are provided by the IHA and include the following:
Read Code—Acquire cache line in a shared only state (RdCode).
Read Data—Acquire cache line in a shared or exclusive state (RdData).
Read Current—Acquire cache line, but retain no state (RdCur).
Read, Invalidate, Own—Acquire cache line in an exclusive or modified state (RdInvOwn).
Invalidate I→E—Acquire exclusive ownership of a cache line, but no data (InvItoE).
Invalidate M/E/S/I→I—Flush cache line to memory (InvXtoI).
Clean Cache Line Eviction E/S→I—Evict cache line from cache which is not modified (EvctCln).
Writeback M→I Partial Data—Writeback and Invalidate a partial cache line (WbMtoIDataPtl).
Writeback M→I Full Data—Writeback and Invalidate a full cache line (WbMtoIData).
Writeback M→S Full Data—Writeback and keep a shared copy of a full cache line (WbMtoSData).
Writeback M→E Full Data—Writeback and keep exclusive a full cache line (WbMtoMData).
Writeback M→E Partial Data—Writeback and keep exclusive a partial cache line (WbMtoEDataPtl).
Maintenance Atomic Read Modify Write—Maintenance Transaction for obtaining a cache line exclusively or modified (MaintRW).
Maintenance Read Only—Maintenance Transaction for obtaining a cache line in the invalid state (MaintRO).

In one embodiment, the expected responses to the above requests include the following:
DataS CMP—Cache data status is shared. Transaction complete. This response also includes a response invalid (RspI), response shared (RspS), response invalid writeback data (RspIWbdata, response invalid), response shared writeback data (RspSWbData).
Grant—Granted. The line of cache may be read from shared memory. This response also includes response invalid writeback data (RspIWbdata), response shared, writeback data (RspSWbData).
Retry—The responding agent is busy, retry request after X time periods.
Conflict—A conflict with the line of cache is detected. This response also includes a response invalid (RspI), response shared (RspS), response invalid writeback data (RspIWbdata, response invalid), response shared writeback data (RspSWbData).
DataE CMP—Cache data status is exclusive. Transaction complete. This response also includes a response invalid (RspI), response invalid writeback data (RspIWbdata, response invalid).
DataI CMP—Cache data status is invalid. Transaction complete. This response also includes a response invalid (RspI), response invalid writeback data (RspIWbdata, response invalid).

DataM CMP—Cache data status is modified. Transaction complete. This response also includes a response invalid (RspI).

A requester may receive snoop responses for a request it issued prior to receiving a home response. Preferentially, the requester is able to receive up to 255 response and invalidate responses for a single issued request. This is based on a maximum size system with 256 SC in as many cells where the requester will not receive a snoop from the home, but possibly all other SCs in cells. Each snoop response and the home response may contain a field that specifies the number of expected snoop responses and if a final completion is necessary. If a final completion is necessary, then the number of expected snoop responses must be 1 indicating that another node had the cache line in an exclusive or modified state. A requester can tell by the home response the types of snoop responses that it should expect. Snoop responses also contain this same information, and the requester normally validates that all responses, both home and snoop, contain the same information.

In one embodiment, the following pseudo code provides the necessary decode to determine the snoop responses to expect.
If Final Cmp Required=Yes
Check Number of Expected Snoop Responses=1
A single snoop should be received, the type is based on the request issued:
RdCode/RdData: RspI,RspS,RspIWbData,RspIWbDataPtl,RspSWbData
RdCur: RspI,RspS,RspIWbdata,RspIWbDataPtl,RspSWbData,RspFwdData
RdInvOwn/InvItoE: RspI,RspIWbData,RspIWbDataPtl
If Final Cmp Required=No
If Number of Expected Snoop Responses>0, then all snoops should be either RspI
Else no snoops should be received.

When a GRA, such as an IHA, receives a snoop request, it preferentially prioritizes servicing of the snoop request and responds to the snoop request in accordance with the snoop request received and the current state of the GRA. A GRA transitions into the state indicated in the snoop response prior to sending the snoop response. For example, if the snoop code is requested and the node is in the exclusive state, the data is written back into memory, rendering it invalid, then an invalid response is sent and the state of the node is set to invalid. In this instance, the node gave up its exclusive ownership of the cache line and made the cache line available for the requesting agent.

In one aspect of the invention, conflicts may arise because two requestors may generate nearly simultaneous requests. In one embodiment, no lock conditions are placed on transactions. Identifiers are placed on transactions such that home agents may resolve conflicts arising from responding agents. By examining the transaction identifiers, the home agent is able to keep track of which response is associated with which request.

Since it is possible to for certain system agents to retry transactions due to conflicts or lack of resources, it is necessary to provide a mechanism to guarantee forward progress for each request and requesting agent in a system. It is the responsibility of the responding agent to guarantee forward progress for each request and requesting agent. If a request is not making forward progress, the responding agent must eventually prevent future requests from being processed until the starved request has made forward progress. Each responding agent that is capable of issuing a retry to a request must guarantee forward progress for all requests.

In one aspect of the invention, the ICA preferably retries a coherent original read request when it either conflicts with another tracker entry or the tracker is full. In one embodiment, the ICA will not retry a coherent original write request. Instead, the ICA will send a convert response to the requester when it conflicts with another tracker entry.

A cache coherent SMP system prevents live locks by guaranteeing the fairness of transactions between multiple requestors. A live lock is the situation in which a transaction under certain circumstances continually gets retried and ceases to make forward progress thus permanently preventing the system or a portion of the system from making forward progress. This present scheme provides a means of preventing live locks by guaranteeing fair access for all transactions. This is achieved by use of a deli counter retry scheme in which a batch processing mechanism is employed to achieve fairness between transactions. It is difficult to provide fair access to requests when retry responses are used to resolve conflicts. Ideally, from a fairness viewpoint, the order of service would normally be determined by the arrival order of the requests. This could be the case if the conflicting requests were queued in the responding agent. However, it is not practical for each responding agent to provide queuing for all possible simultaneous requests within a systems capability. Instead, it is sometimes necessary to compromise, seeking to maximize performance, sometimes at the expense of arrival order fairness, but only to a limited degree.

In a cache coherent SMP system, multiple requests are typically contending for the same resources. These resource contentions are typically due to either the lack of a necessary resource that is required to process a new request or a conflict exists between a current request being processed and the new request. In either case, the system employs the use of a retry response in which a request is instructed to retry the request at a later time. Due to the use of retries for handling conflicts, there exist two types of requests; new requests and retried requests.

A new request is one in which the request was never previously issued. A retry request is the reissuing of a previously issued request that received a retry response indicating the need for the request to be retried at a later time due to a conflict. When a new or retry request encounters a conflict, a retry response is sent back to the requesting agent. The requesting agent preferably then re-issue the request at a later time.

The retry scheme provides two benefits. The first is that the responding agent does not require very large queue structures to hold conflicting requests. The second is that retries allow requesting agents to deal with conflicts that occur when a snoop request is received that conflicts with an outstanding request. The retry response to the outstanding request is an indication to the requesting agent that the snoop request has higher priority than the outstanding request. This provides the necessary ordering between multiple requests for the same address. Otherwise, with out the retry, the requesting agent would be unable to determine whether the received snoop request precedes or follows the pending request.

In one embodiment of the system, it is expected that the Remote ICA (Intermediate Coherency Agent) in the Coherency Director (CD) will be the only agents capable of issuing a retry to a coherent memory request. A special case is one in which a coherent write request conflicts with a current coherent read request. The request order preferably ensures that the snoop request is ordered ahead of the write request. In this case, a special response is sent instead of a retry response. The special response allows the requesting agent to provide the write data as the snoop result; the write request, however, is not resent. The memory update function can either be the responsibility of the recipient of the snoop response or alternately memory may have been updated prior to issuing the special response.

The batch processing mechanism provides fairness in the retry scheme. A batch is a group of requests for which fairness will be provided. Each responding agent will assign all new requests to a batch in request arrival order. Each responding agent will only service requests in a particular batch insuring that all requests in that batch have been processed before servicing the next sequential batch. Alternately, to improve performance the responding agent can allow the processing of requests from two or more consecutive batches. The maximum number of consecutive batches must be less than the maximum number of batches in order to guarantee fairness. Allowing more than one batch to be processed can improve processing performance by eliminating the situations where processing is temporarily stalled waiting for the last request in a batch to be retried by the requester. In the meantime, the responding agent has many resources available but continues to retry all other requests. The processing of multiple batches is preferably limited to consecutive batches and fairness is only guaranteed in the window of sequential requests which is the sum of all requests in all simultaneous consecutive batches. Thus ultimately it is possible for the responding agent to enter a situation where it must retry all requests while waiting for the last request in the first batch of the multiple consecutive batches to be retried by the requester. Until that last request is complete the processing of subsequent batches is prevented, however having multiple consecutive batches reduces the probability of this situation compared to having a single batch. When processing consecutive batches, once the oldest batch has been completely processed, processing may begin on the next sequential batch, thus the consecutive batch mechanism provides a sliding window effect.

In one embodiment, the responding agent assigns each new request a batch number. The responding agent maintains two counters for assigning a batch number. The first counter keeps track of the number of new requests that have been assigned the same batch number. The first counter is incremented for each new request, when this counter reaches a threshold (the number of requests in a batch), the counter is reset and the second counter is incremented. The second counter is simply the batch number, which is assigned to the new request. All new requests cause the first counter to increment even if they do not encounter a conflict. This is required to prevent new requests from continually causing retried requests from making forward progress.

Additionally, the batch processing mechanism may require a new transaction to be retried even though no conflict is currently present in order to enforce fairness. This can occur when the responding agent is currently not processing the new request's assigned batch number. If a new request requires a retry response due to either a conflict or enforcement of batch fairness, the retry response preferably contains the batch number that the request should send with each subsequent attempted retry request until the request has completed successfully. The batch mechanism preferably dictates that the number of batches multiplied by the batch size be greater than all possible simultaneous requests that can be present in the system by at least the number of batches currently being serviced multiplied by the batch size. Additionally, the minimum batch size is preferably a factor in a few system parameters to insure adequate performance. These factors include the number of resources available for handling new requests at the responding agent and the round-trip delay of issuing a retry response and receiving the subsequent retry request. The USP Protocol allows the maximum number of simultaneous requests in the system to be 256 SC IDs×64 Function IDs×256 Transaction IDs=4,194,304 requests. Thus, the request and response packet formats provide for a 12 bit retry batch number, the minimum batch size is calculated as follows:
N requests/batch>4,194,304 requests/4096 batches N>1024 requests

Therefore, the minimum batch size for the present SMP system is 2048 requests. Batch size could vary from batch to batch, however it is typically easier to fix the size of batches for implementation purposes. It is also possible to dynamically change the batch size during operation allowing system performance to be tuned to changes in latency, number of requestors, and other system variables. The responding agent preferably tracks which batches are currently being processed, and it preferably keeps track of the number of requests from each batch that have been processed. Once the oldest batch has been completed (all requests for that batch have been processed), the responding agent may then begin processing the next sequential batch, and disable processing of the completed batch thus freeing up the completed batch number for reallocation to new requests in the future. In alternate implementations where multiple consecutive batches are used to improve system performance, processing may only begin on a new batch when the oldest batch has been finished. If a batch other than the oldest batch has finished processing, the responding agent preferably waits for the oldest batch to complete before starting processing of one or more new batches.

When a responding agent receives a retry request, the batch number contained in the retry request is checked against the current batch numbers being processed by the responding agent. If the retry request's batch number is not currently being processed, the responding agent will retry the request again. The requesting agent must retry the request at a later time with the batch number from the first retry response it had originally received for that request. The responding agent may additionally retry the retry request due to a new or still unresolved conflict. Initially and at other relatively idle times, the responding agent is processing the same batch number that is also currently being allocated to new requests. Thus, these new requests can be immediately processed assuming no conflicts exist.

In one embodiment, the USP utilizes a deli counter mechanism to maintain fairness of original requests. The USP specification allows original requests, both coherent and non-coherent, to be retried at the destination back to the source. The destination guarantees that it will eventually accept the request. This is accomplished with the deli counter technique. The deli counter is includes two parts. The first part is the batch assignment circuit, and the second part is the batch acceptance circuit. The batch assignment circuit is a counter. The USP performance allows for a maximum number of outstanding transactions based on the following three fields: source SC ID[7:0], source function ID[5:0], and source transaction ID[7:0]. This results in a maximum of 222 or approximately 4M outstanding transactions.

The batch assignment counter is preferably capable of assigning a unique number to each possible outstanding transaction in the system with additional room to prevent reuse of a batch number before that batch has completed. Hence it is 23 bits in size. When a new original request is received, the request is assigned the current number in the counter, and the counter is incremented. Certain original requests are never retried, and hence do not get assigned a number, such as coherent writes. The deli counter enforces only batch fairness. Batch fairness infers that a group of transactions are treated with equal fairness. The USP employs the batch number to be the most significant 12 bits of the batch assignment counter. If a new request is retried, the retry contains the 12 bit batch number. A requester is obligated to issue retry requests with the batch number received in the initial retry response. Retried original requests can be distinguished between new original requests via the batch mode bit in the request packet. The batch acceptance circuit is designed to determine if a new request or retry request should be retried due to fairness.

The batch acceptance circuit considers requests that fall into one of two consecutive batches that are currently being serviced to pass through. If a request's batch number falls outside of the two consecutive batches currently being serviced, the request should immediately be retried for fairness reasons. Each time a packet that falls within the two consecutive batches that are currently being serviced, if the packet is fully accepted and not retried for another reason such as conflict or resource, then a counter is incremented indicating that a packet has been serviced. The batch acceptance circuit maintains two 11 bit counters, one for each batch currently being serviced. Once a request is considered complete to the point where it will not be retried again, the corresponding counter is incremented. Once that counter has rolled over, the batch is considered complete, and the next batch may begin to be serviced. Batches must be serviced in consecutive order, so unless the oldest batch has completed, a new batch may not begin to be serviced until the oldest batch has completed servicing all requests in that batch.

Thus, the two consecutive batches are considered to leap frog each other. In the even the newer batch being serviced completes all requests before the oldest batch being serviced, then the batch acceptance circuit must wait until the oldest batch has serviced all requests before allowing a new batch to be serviced. The ICA applies deli counter fairness to the following requests: RdCur, RdCode, RdData, RdInvOwn, RdInvItoE, MaintRW, MaintRO.

As mentioned above, while exemplary embodiments of the invention have been described in connection with various computing devices, the underlying concepts may be applied to any computing device or system in which it is desirable to implement a multiprocessor cache coherency system. Thus, the methods and systems of the present invention may be applied to a variety of applications and devices. While exemplary names and examples are chosen herein as representative of various choices, these names and examples are not intended to be limiting. One of ordinary skill in the art will appreciate that there are numerous ways of providing hardware and software implementations that achieves the same, similar or equivalent systems and methods achieved by the invention.

As is apparent from the above, all or portions of the various systems, methods, and aspects of the present invention may be embodied in hardware, software, or a combination of both. For example, the elements of a cell may be rendered in an application specific integrated circuit (ASIC) which may include a standard or custom controller running microcode as part of the included firmware.

While the present invention has been described in connection with the preferred embodiments of the various figures, it is to be understood that other similar embodiments may be used or modifications and additions may be made to the described embodiment for performing the same function of the present invention without deviating therefrom. Therefore, the invention should not be limited to any single embodiment, but rather should be construed in breadth and scope in accordance with the appended claims.

What is claimed:

1. A system for maintaining cache coherency in multiprocessor environment, the system comprising:
a first multiprocessor assembly comprising at least two processors, each processor having local cache to store at least one cache line;
a first coherency director (CD) comprising a first intermediate home agent (IHA) and a first intermediate cache agent (ICA), wherein the CD is coupled to the first multiprocessor assembly;
a first remote directory coupled to the CD, wherein the remote directory stores cache location information;
a first memory providing cache data to the first processor assembly;
wherein the first multiprocessor assembly, the first CD, the first remote directory, and the first memory comprise a first cell;
a second cell having a second multiprocessor assembly, a second CD, a second remote directory, and a second memory, wherein the second CD comprises a second IHA and a second ICA; and
interconnections between the first IHA and the second ICA and between the second IHA and the first ICA, wherein requests and responses for cache information are communicated between the first cell and the second cell such that the first IHA of the first cell requests cache information from the second ICA of the second cell and the second IHA of the second cell requests cache information from the first ICA of the first cell.

2. The system of claim 1, further comprising a first system controller and a second system controller, wherein respective system controllers coordinate events within each cell.

3. The system of claim 1, wherein the first and second memory comprise one or more of a centralized memory and a distributed memory.

4. The system of claim 1, wherein the requests for cache information communicated between the first cell and the second cell comprise requests to read cache status and data.

5. The system of claim 1, wherein the responses for cache information communicated between the first cell and the second cell comprise a retry request if the responding cell is unable to provide the information requested.

6. The system of claim 1, wherein the first remote directory stores cache location and status information for lines of cache that are associated with the first processor assembly which are being used by processors of the second cell.

7. A method of obtaining a line of cache in a cache coherent multiprocessor system comprising at least two cells of multiprocessor assemblies, the method comprising:
requesting a line of cache from a first processor in a first multiprocessor assembly in a first cell, the request being sent to an intermediate home agent (IHA) of the first cell;
reading a location of the requested line of cache from a remote directory in the first cell;
sending the request for the line of cache from the IHA of the first cell to an intermediate cache agent (ICA) of a second cell;
transferring the request for the line of cache from the ICA of the second cell to the IHA of the second cell;
snooping the processors of the second cell for the requested line of cache, wherein processors in the second cell respond to the request by returning status to the IHA of the second cell;
making the line of cache available for use;
sending response information from the second cell to the first cell where the ICA of the second cell communicates with the IHA of the first cell;
receiving the requested cache information by the first cell and transferring the information to the first processor of the first cell, whereby the line of cache information is available to fill the request of the first processor in the first cell.

8. The method of claim 7, further comprising:
updating the remote directory information of the first cell to indicate that the line of cache is no longer held by the second cell.

9. The method of claim 7, further comprising:
retrying the step of sending the request for the line of cache from the IHA of the first cell to the ICA of the second cell if the second cell indicates unavailability.

10. The method of claim 9, wherein the step of retrying is executed after a predetermined interval.

11. The method of claim 10, wherein the predetermined interval is provided by the second cell in response to a first send request to the IHA of the second cell.

12. The method of claim 7, wherein snooping the processors of the second cell comprises sending out requests for the line of cache to each processor in the second cell.

13. The method of claim 7, wherein making the line of cache available for use comprises releasing the requested line of cache by writing back the line of cache into memory and responding that the line of cache is available.

14. The method of claim 7, wherein sending the request for the line of cache from the IHA of the first cell to an intermediate cache agent (ICA) of a second cell comprises sending the request to the ICA of the second cell, wherein the ICA of the second cell comprises a batch processing mechanism.

15. The method of claim 14, wherein the batch processing mechanism assigns all incoming requests in arrival order and processes the requests in batch order.

16. The method of claim 15, wherein the batch order comprises processing request from two consecutive batches simultaneously.
